(19) United States
(12) Patent Application Publication
(10) Pub. No.: US 2025/0259190 A1
(43) Pub. Date: Aug. 14, 2025

(54) Predictive Traits

(71) Applicant: Twilio Inc., San Francisco, CA (US)

(72) Inventors: Troy Bolus, San Francisco, CA (US); Sophia Somin Yoo, Brooklyn, NY (US); Carlos Alberto Oliveira, San Diego, CA (US); Ankit Awasthi, San Francisco, CA (US); Alfredo Lainez Rodrigo, Madrid (ES); Matthew Raporte, Newport Beach, CA (US); Akshay Chandrashekaran, Boston, MA (US); Sebastian Montes, Madrid (ES); Pilar Gallego, Madrid (ES); Rowan Michael Wing, Logmont, CO (US); Nicole Woytarowicz, Allen, TX (US); Enyi Asonye, Austin, TX (US); Afgan Talpur, Whitby (CA); Chih-Chun Lin, Irvine, CA (US); Megha Dhingra, Berkeley, CA (US); Zach Keller, Chicago, IL (US)

(21) Appl. No.: 18/439,050

(22) Filed: Feb. 12, 2024

(51) Int. Cl. G06Q 30/0202; G06Q 10/0631; G06Q 30/0204

(52) U.S. Cl. CPC G06Q 30/0202; G06Q 10/06315; G06Q 30/0205

(57) ABSTRACT

Systems and methods for on-demand creation, evaluation and/or deployment of machine learning (ML) models for computing the value of a predictive trait. System operations include detecting, at a predictive trait user interface (UI), a selection of a predictive trait of a plurality of predictive traits and a selection of a configuration setting for the predictive trait. System operations further include executing, using an orchestrator, an onboarding flow that retrieves user data, a training workflow that generates a trained predictive trait model, and/or an inference workflow that runs the trained predictive trait model to compute predictive trait values for users in a test set. System operations further include generating and displaying, via the predictive trait UI, explanations associated with the trained predictive trait model, the computed predictive trait values, and the test set. The system further transmits computed predictive values to an audience management service for audience generation or user profiling.

### CROSS-REFERENCE TO RELATED APPLICATIONS

This application claims the benefit of Spanish Application No. P202330260, filed on Mar. 28, 2023, which is hereby incorporated by reference in its entirety.

### BACKGROUND

Marketers and businesses are interested in tracking and profiling customers or users in order to improve marketing or e-mail campaigns. For example, having an in-depth, up-to-date understanding of user profiles and behaviors will allow a marketer to improve message personalization, update pricing offers, or vary the frequency of communications with the users.

### BRIEF DESCRIPTION OF THE SEVERAL VIEWS OF THE DRAWINGS

In the drawings, which are not necessarily drawn to scale, like numerals may describe similar components in different views. To easily identify the discussion of any particular element or act, the most significant digit or digits in a reference number refer to the figure number in which that element is first introduced. Some embodiments are illustrated by way of example, and not limitation, in the figures of the accompanying drawings.

FIG. 1 is a network diagram illustrating a system within which various example embodiments may be deployed.

FIG. 2 is a block diagram illustrating a view of a predictive trait system that includes a framework for training, evaluating, or deploying trait prediction models, according to some examples.

FIG. 3 is a block diagram illustrating a view of a predictive trait system, according to some examples.

FIG. 4 is a block diagram illustrating a partial view of a predictive trait system, according to some examples.

FIG. 5 is a flowchart illustrating a method as implemented by a predictive trait system, according to some examples.

FIG. 6 is an illustration of a view of a user interface (UI) for a predictive trait system, according to some examples.

FIG. 7 is an illustration of a view of trait configuration for a selected trait within a UI for a predictive trait system, according to some examples.

FIG. 8 is an illustration of a visualization of trait prediction-related data within a UI for a predictive trait system, according to some examples.

FIG. 9 is an illustration of a selection of a trait within a UI for a predictive trait system, according to some examples.

FIG. 10 is an illustration of a configuration of a trait within a UI for a predictive trait system, according to some examples.

FIG. 11 is an illustration of a visualization of trait prediction-related data within a UI for a predictive trait system, according to some examples.

FIG. 12 is an illustration of a visualization of trait prediction-related data within a UI for a predictive trait system, according to some examples.

FIG. 13 is a block diagram illustrating an example of a software architecture that may be installed on a machine, according to some example embodiments.

FIG. 14 is a block diagram illustrating components of a machine, according to some example embodiments, able to read instructions from a machine-readable medium (e.g., a machine-readable storage medium) and perform any one or more of the methodologies discussed herein.

FIG. 15 is a block diagram showing a machine-learning (ML) program, according to some examples.

### DETAILED DESCRIPTION

Building robust, flexible frameworks for large-scale tracking and/or profiling of customers or users of businesses and/or platforms is of great interest and has attracted a lot of effort and investment. Such frameworks should be scalable, flexible, should be able to automatically incorporate on-demand task selection, creation or configuration requests into their underlying model construction mechanisms, and they should execute the requisite profiling or prediction tasks in a robust, efficient, transparent fashion. Examples of such tasks include predicting future user traits or behavior (e.g., a user's likelihood to make a purchase, or click on a link), which can help with communication frequency, pricing offers, message personalization (fine-tuning the content of an ad, email or website), helping decide which users to include or exclude in marketing or e-mail campaigns, or other use cases.

The example embodiments disclosed herein include a novel framework for on-demand creation, evaluation, and/or deployment of machine learning (ML) models to predict values of user traits. The framework has the ability to flexibly generate customized models that compute the likelihood of one or more future actions over a specified time period. This ability can enable personalized predictive profiling of user behavior and tendencies, scoring users, on-demand audience generation for campaigns or sale efforts, and other applications.

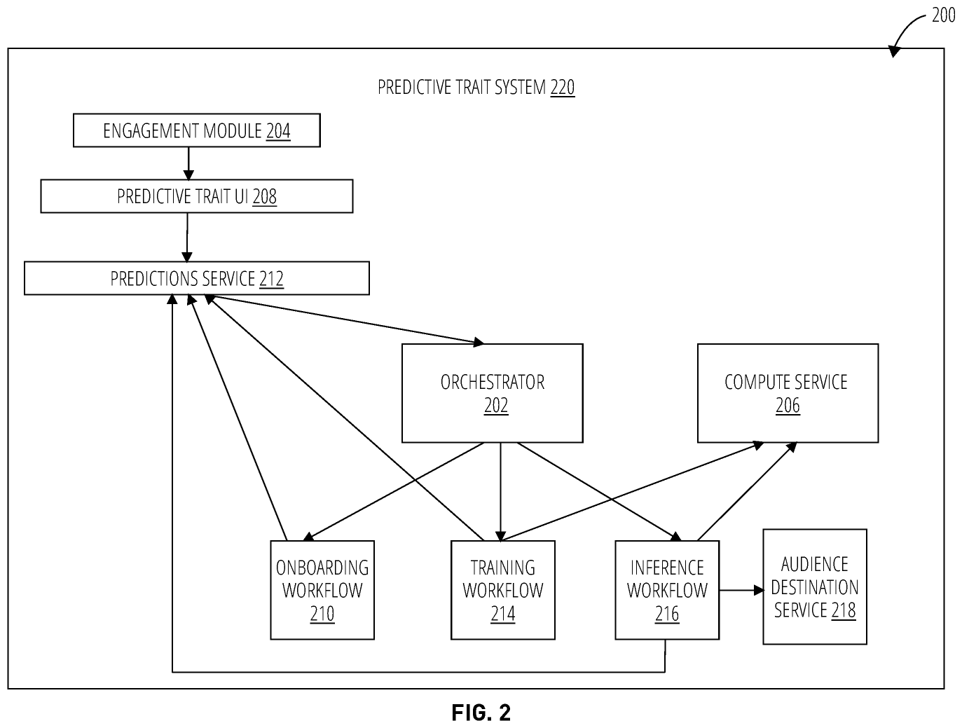

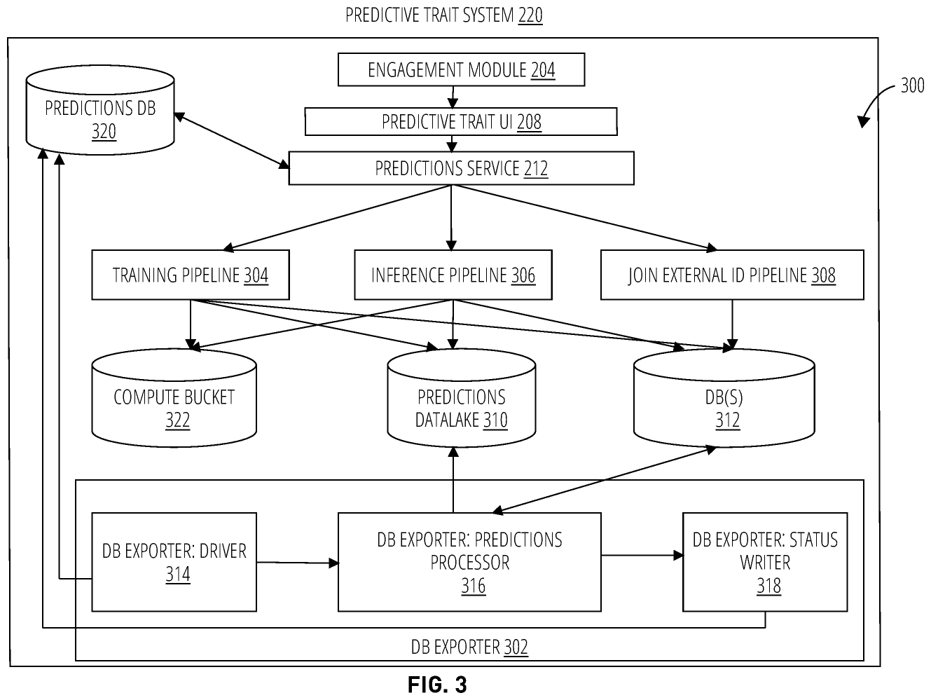

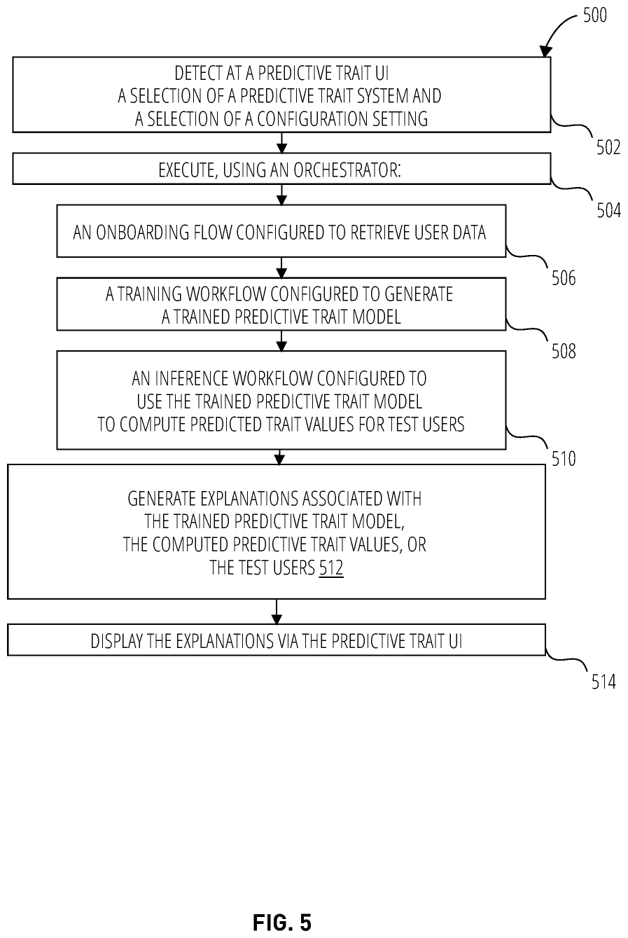

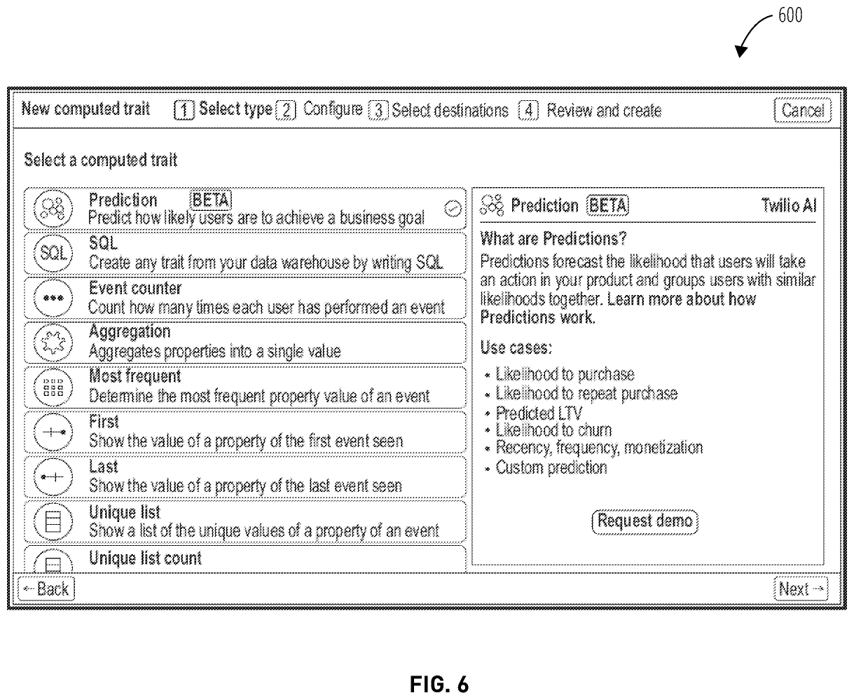

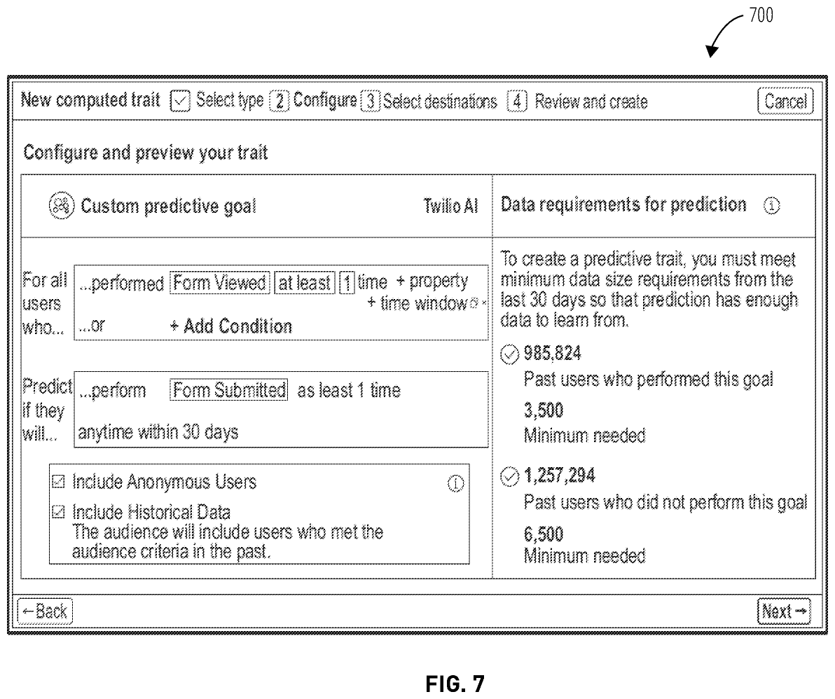

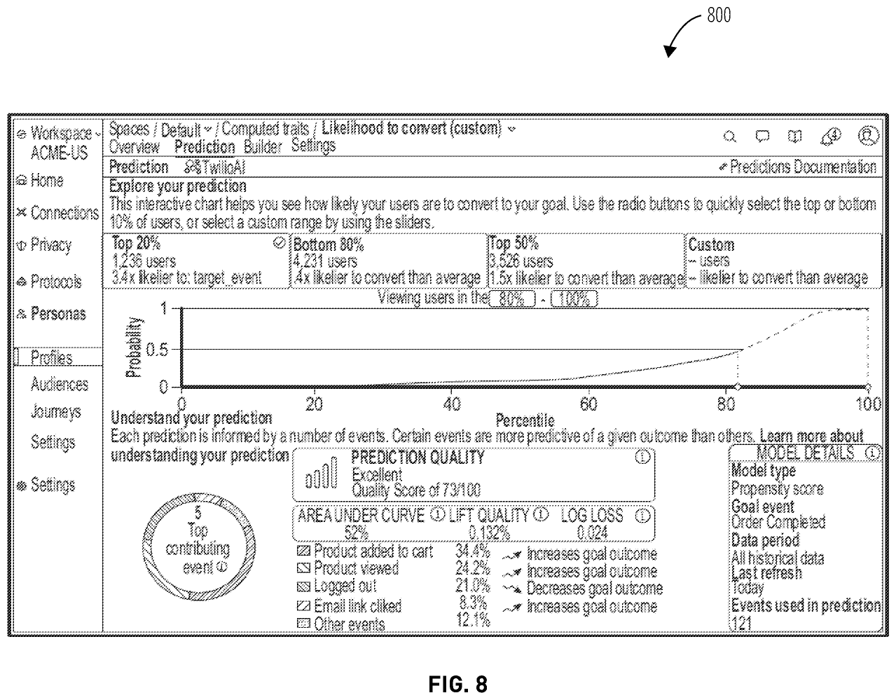

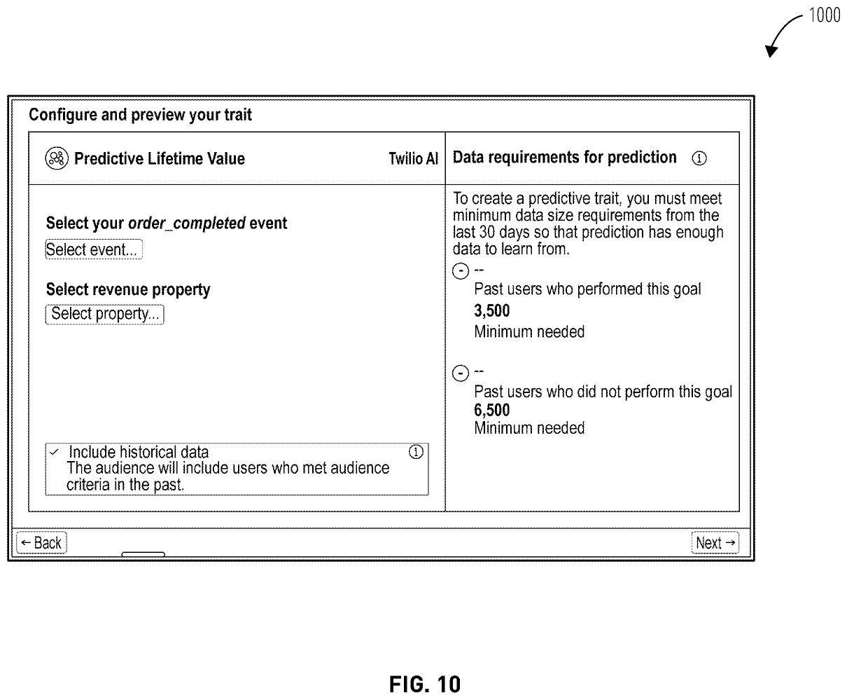

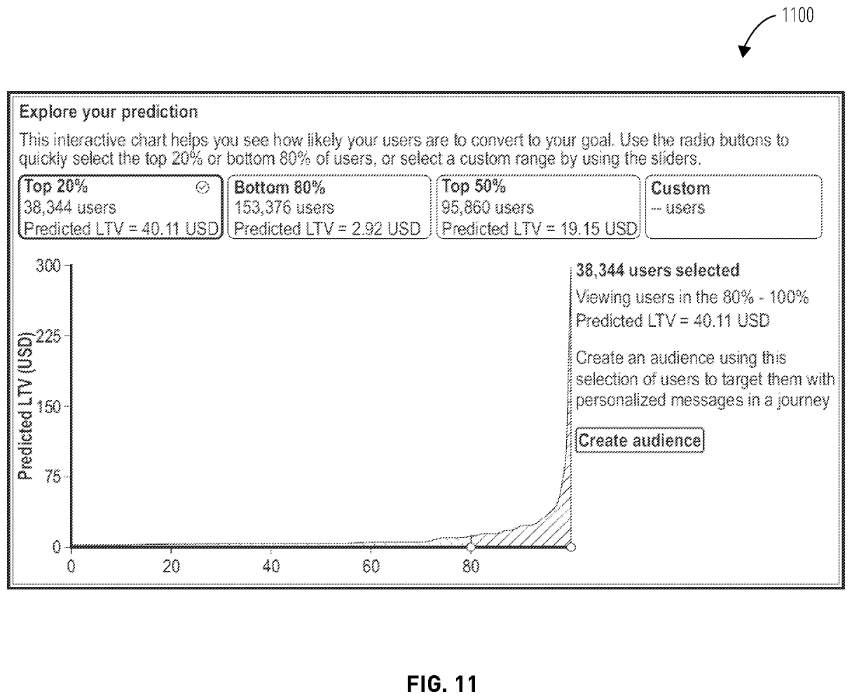

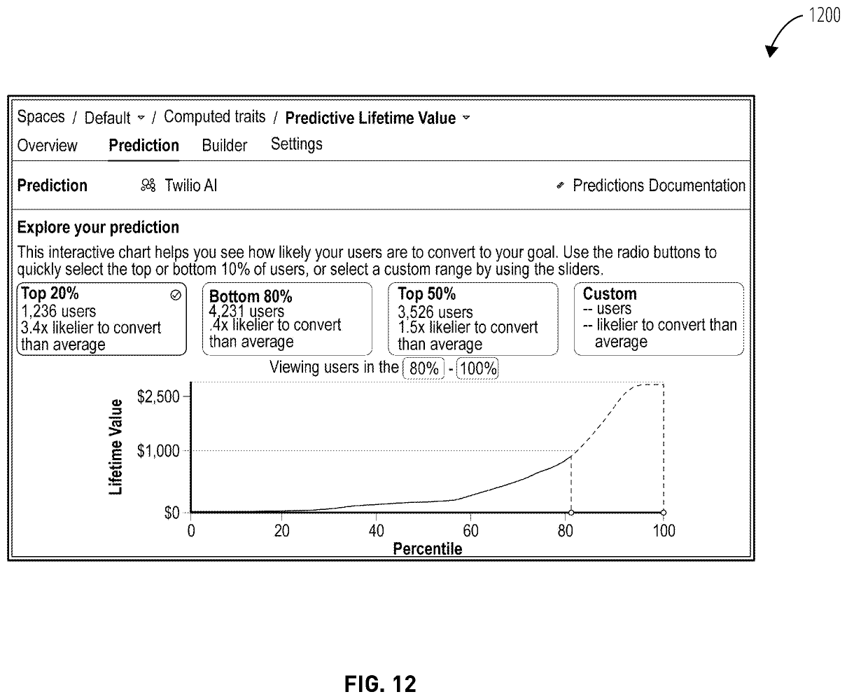

Examples disclosed herein include a predictive trait system architecture with several innovative components, including an engagement module for user interaction, a predictive trait UI for model configuration and/or selection, a predictions service that handles model training and deployment workflows, and/or an orchestrator that coordinates and automates the workflows. Models predict likelihood of future user actions over specified time periods rather than just categorizing users based on past behaviors, allowing for improved actionable predictions (see at least FIG. 5 and FIG. 7). A predictive trait UI for model selection and/or configuration allows for ease-of-use and flexibility (see at least FIG. 6, and/or configuration workflows in FIG. 7 or FIG. 10.) Automated pipelines are provided for onboarding, model training, inference and post-processing (see at least FIG. 2 and FIG. 3). This allows for scalable and efficient model development and usage. Intuitive visualizations are generated to explain model and prediction characteristics (see at least FIG. 8, FIG. 11, FIG. 12). The system displays top performing features of models, relative feature importance, and/or percentile statistics showing prediction score distributions across user populations. Model interpretability and result summaries facilitate understanding and trust in the system. In summary, novel aspects include at least an on-demand trait modeling framework, predictive scoring approaches, interaction and automation capabilities, and/or model explainability visualizations.

Examples disclosed herein refer to a system (e.g., a predictive trait system) that includes a framework for on-demand creating, characterizing, evaluating, and/or deploying machine learning (ML) models for predicting the value of a user trait. The on-demand ML models for trait prediction score users by computing the likelihood of a future user action, or predefined conversion event, over a future period of time (e.g., the next 30 days). A system user (e.g., a marketer) can select and/or customize, via a user interface (UI) for the system, a trait of interest such as a predefined trait, or a new, custom predictive goal. Once a system user reviews, creates and/or customizes the final trait, the predictive trait system will train, evaluate, and/or deploy for inference a ML model corresponding to the selected or created trait. Creating the training set (training audience) or the test set (e.g., inference audience) can involve user input in the form of selecting or specifying characteristics of the training data or test data via a UI for the predictive trait system. Once a trained trait-specific prediction model computes trait prediction scores or values for each user in the test set, the predictive trait system can send the computed scores to destinations within an audience destination service, where they can be used in the building of audiences, or it can add them to customer journeys. The predictive trait system displays visualizations of prediction model characteristics such as top performing features (or most important features), and/or automatically derived characteristics of the test set or training set, such as percentile cohorts.

Computing predictive traits is particularly useful for difficult to measure outcomes such as user activation, retention, engagement, or long-term value journeys. Predicting user behavior and/or trait values exhibits increased robustness and usefulness for products or platforms with a large number of users (e.g., 100,000 average monthly users or more). The system can use on-demand, trait specific prediction models in order to easily build different types of audiences or cohorts (e.g., predicts groups of at-risk or VIP customers, rather than reverse engineering behaviors), create better campaigns based on what a user will do in the future rather than their past behavior, create predictive models without a need for specialized additional data science expertise, understand how the model was built and/or why it performs as it does, or build campaigns with lower customer acquisition costs (CAC) and higher conversion rates. Additionally, the system can use easily trainable and customizable models for predictive traits to build audiences faster, directly use ML to improve targeting specific users or audiences, track how the likelihood of a user taking a certain action (e.g., propensity to take an action, propensity scores, etc.) changes for the user over time, or offload audience creation to other systems (e.g., marketing systems) in order to focus on additional initiatives or business problems.

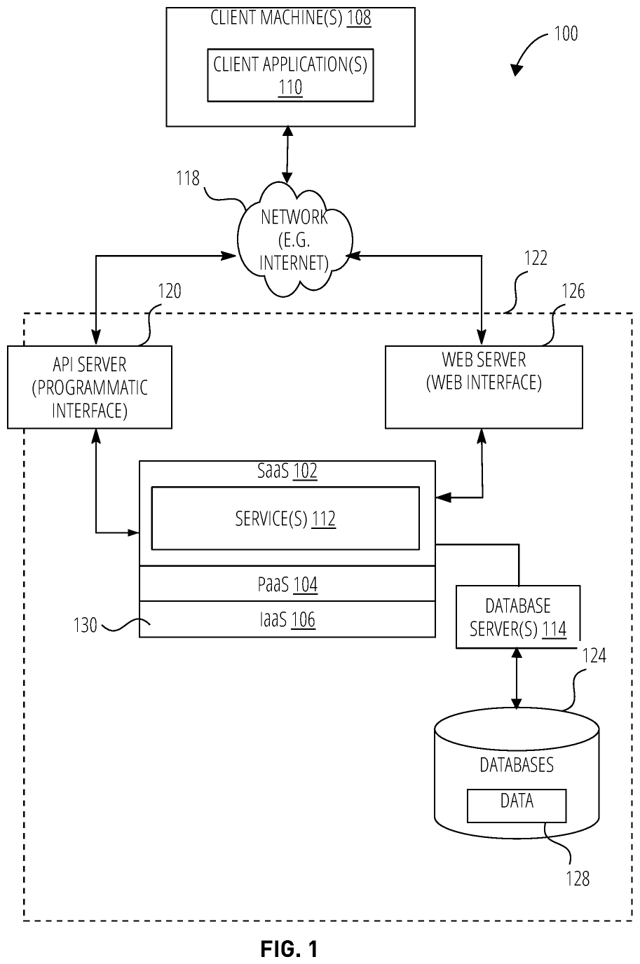

FIG. 1 is a network diagram depicting a system 100 within which various example embodiments may be deployed (such as a predictive trait system 220 illustrated in FIG. 2 and FIG. 3). A networked system 122 in the example form of a cloud computing service, such as Microsoft Azure or other cloud service, provides server-side functionality, via a network 118 (e.g., the Internet or Wide Area Network (WAN)) to one or more endpoints (e.g., client machine(s) 108). FIG. 1 illustrates client application(s) 110 on the client machine(s) 108. Examples of client application(s) 110 may include a web browser application, such as the Internet Explorer browser developed by Microsoft Corporation of Redmond, Washington or other applications supported by an operating system of the device, such as applications supported by Windows, iOS or Android operating systems. Examples of such applications include e-mail client applications executing natively on the device, such as an Apple Mail client application executing on an iOS device, a Microsoft Outlook client application executing on a Microsoft Windows device, or a Gmail client application executing on an Android device. Examples of other such applications may include calendar applications, file sharing applications, and contact center applications. Each of the client application(s) 110 may include a software application module (e.g., a plug-in, add-in, or macro) that adds a specific service or feature to the application.

An API server 120 and a web server 126 are coupled to, and provide programmatic and web interfaces respectively to, one or more software services, which may be hosted on a software-as-a-service (SaaS) layer or platform 102. The SaaS platform may be part of a service-oriented architecture, being stacked upon a platform-as-a-service (PaaS) layer 104 which, may be, in turn, stacked upon a infrastructure-as-a-service (IaaS) layer 106 (e.g., in accordance with standards defined by the National Institute of Standards and Technology (NIST)).

While the applications (e.g., service(s)) 112 are shown in FIG. 1 to form part of the networked system 122, in alternative embodiments, the applications 112 may form part of a service that is separate and distinct from the networked system 122.

Further, while the system 100 shown in FIG. 1 employs a cloud-based architecture, various embodiments are, of course, not limited to such an architecture, and could equally well find application in a client-server, distributed, or peer-to-peer system, for example. The various server applications 112 could also be implemented as standalone software programs. Additionally, although FIG. 1 depicts machines 108 as being coupled to a single networked system 122, it will be readily apparent to one skilled in the art that client machine(s) 108, as well as client applications 110, may be coupled to multiple networked systems, such as payment applications associated with multiple payment processors or acquiring banks (e.g., PayPal, Visa, MasterCard, and American Express).

Web applications executing on the client machine(s) 108 may access the various applications 112 via the web interface supported by the web server 126. Similarly, native applications executing on the client machine(s) 108 may access the various services and functions provided by the applications 112 via the programmatic interface provided by the API server 120. For example, the third-party applications may, utilizing information retrieved from the networked system 122, support one or more features or functions on a website hosted by the third party. The third-party website may, for example, provide one or more promotional, marketplace or payment functions that are integrated into or supported by relevant applications of the networked system 122.

The server applications 112 may be hosted on dedicated or shared server machines (not shown) that are communicatively coupled to enable communications between server machines. The server applications 112 themselves are communicatively coupled (e.g., via appropriate interfaces) to each other and to various data sources, so as to allow information to be passed between the server applications 112 and so as to allow the server applications 112 to share and access common data. The server applications 112 may furthermore access one or more databases 124 via the database servers 114. In example embodiments, various data items are stored in the databases 124, such as the system's data items 128. In example embodiments, the system's data items may be any of the data items described herein.

Navigation of the networked system 122 may be facilitated by one or more navigation applications. For example, a search application (as an example of a navigation application) may enable keyword searches of data items included in the one or more databases 124 associated with the networked system 122. A client application may allow users to access the system's data 128 (e.g., via one or more client applications). Various other navigation applications may be provided to supplement the search and browsing applications.

FIG. 2 is a block diagram illustrating a view of a predictive trait system 220 that includes a framework for creating, training and/or deploying models (e.g., machine learning models) that compute values of predictive traits (or traits) and/or associated likelihood scores.

Traits correspond to user actions, predefined events (e.g., conversion events such as a user purchase or a user click event, events involving one or more user actions), user behaviors, user attributes, and/or other trait types. Traits can include customer lifetime value (LTV), purchase actions (e.g., for specific objects or types of purchases), repeating purchase actions, customer churn, and more (for example, see FIG. 6). Thus, predicting trait values can refer to computing the likelihood of a user taking (or forgoing) a pre-defined action over a future time period, computing the likelihood of a pre-defined event taking place during or over a future time period, computing the likelihood of a particular value for a user behavior or attribute, computing an estimated value of a particular user behavior, attribute or other user-involved trait, and/or other types of prediction and estimation. The future time period can have a predefined duration (e.g., the next 7/14/30 days, the next 2/3/6 months, etc.).

In some examples, a predictive trait system 220 includes an engagement module 204, a predictive trait UI 208 and a predictions service 212. The engagement module 204 enables a system user (e.g., a marketer, a business, etc.) to start engaging with the system (e.g., by selecting a prediction user selectable UI element that indicates an interest in using a predictive trait model). The predictive trait UI 208 includes selectable UI elements that, upon selection by the system user, allow the user to choose one or more of a set of traits for which the system will compute a prediction, configure a specific predictive trait, or create and/or configure a new predictive trait. For example, the system user can configure an already selected predictive LTV trait by selecting an “order_completed” event and a “revenue” property (see at least FIG. 3 and FIG. 10 for details).

Once a trait has been selected, configured and/or created (e.g., via the predictive trait UI 208), the predictive trait UI 208 executes one or more calls (e.g., API calls) to the predictions service 212, which is responsible for running pipelines for training trait-specific models and/or pipelines for performing inference using trained trait-specific models (see at least FIG. 3.) The predictions service 212 communicates with an orchestrator 202 (e.g., a component of the predictive trait system 220, for instance a Conductor orchestration engine managed by Orkes, or an orchestration engine within any other workflow orchestration platform). The orchestrator 202 schedules workflows such as onboarding workflow 210, a training workflow 214 and an inference workflow 216. The workflows run one or more processes related to the training, evaluation, and/or deployment of models for predicting selected traits.

In some examples, the onboarding workflow 210 starts subsequent to the detection, by the orchestrator 202, of a communication from the predictions service 212. An example such communication comprises information about a selected and/or configured trait for which to build, evaluate, or deploy a prediction model. The onboarding workflow 210 can start in response to the predictive trait system 220 detecting that a system user requests access to the predictive trait UI or predictive trait functionality, for example by engaging with the predictive trait UI 208 as described above. In some examples, the onboarding workflow 210 creates a system user (or customer) workspace, used for example to enable database (DB) exports of needed customer data, as detailed in the FIG. 3 discussion. The onboarding workflow 210 enables a feature flag indicating that the user has access to the predictive trait (or trait prediction) functionality starting at a specific point in time. The onboarding workflow 210 communicates with the predictions service 212 to transmit namespace information (e.g., customer information).

In some examples, a training workflow 214 runs a training process. The training workflow 214 checks whether it has access to a set of necessary data or DB exports (e.g., necessary customer data for a given period, etc.). The training workflow 214 creates a training set (e.g., a training audience) and runs a training pipeline 304 for a model (e.g., a machine learning model) that predicts a selected, customized trait (e.g., predicting the likelihood of a future action or conversion event, etc.) (e.g., see FIG. 3 for an example training pipeline 304). The training workflow 214 creates a training set (e.g., training audience) by using a compute service 206. The training workflow 214 can store the data about the members of the training audience either locally, or in remote storage (e.g., using compute bucket 322 as seen in FIG. 3). The predictive trait system 220 periodically computes and/or monitors a comprehensive set of metrics to ensure the health of production models. Such measures track various stability indicators for model performance over time and over populations or specific characteristics (e.g., a Population Stability Index, a Characteristics Stability Index, etc.). The predictive trait system 220 uses a set of criteria and operations or decision logic to trigger model retraining, fresh data collection, and/or other steps in order to improve the health of the deployed models. The training workflow 214 retrains a trained model with fresh data using a time-based schedule and/or a performance-based schedule (e.g., daily/weekly/monthly, etc., triggered by a drop in a periodically-assessed performance of the model, or based on other pre-defined triggering events).

In some examples, an inference workflow 216 runs an inference process. The inference workflow 216 creates an evaluation or test set (e.g., an inference audience). The inference workflow 216 runs an inference pipeline 306 and/or a join external ID pipeline 308 (see FIG. 3 for details). The inference pipeline 306 retrieves a trained prediction model for a trait and computes prediction results for the trait of interest over the evaluation or test set (e.g., for each customer included in the test set or inference audience). The trait prediction results are synchronized with user profiles and/or specific destinations within an audience destination service 218. Post-inference outputs (e.g., percentiles, stats, other model explainability quantities, null trait values for non-active users) are computed, for example by the join external ID pipeline 308 (see at least FIG. 3). Such post-inference outputs are uploaded or synchronized, by the inference workflow 216 via a sync workflow with audience destination service 218. Such post-inference outputs can be displayed to the system user via one or more UIs.

FIG. 3 is a block diagram illustrating a view of a predictive trait system 220 that includes a framework for creating, training, and/or deploying predictive trait models, according to some examples. Predictive trait models are ML models that predict values of traits and/or associated likelihood scores. As described in FIG. 2, predicting trait values can refer to computing the likelihood of a user taking (or forgoing) a pre-defined action over a future time period, the likelihood of a pre-defined event taking place during or over a future time period, the likelihood of a particular value for a user behavior or attribute, computing an estimated or expected value of a particular user behavior, attribute or other user-involved trait, and other types of prediction or estimation. The future time period can have a predefined duration (e.g., the next 7/14/30 days, etc.).

### Trait-Specific ML Models

### Feature Set and Development Set Construction

In some examples, the models (e.g., ML models) can use any relevant type of data for constructing/augmenting a training set and/or generating features. For example, given an event type (e.g., “page_visit”) and associated event stream, features can include event-stream based features and/or timestamp-related features (e.g., number of page visits in the past K days by a user, average time between page visits in the past K days by a user, time of last page visit by a user in the past K days, etc.). Examples of additional event stream and time-stamp related features that capture information such as frequency, recency, trends or ratios derived based on a sequence of recorded events or actions for each user include: number of purchases on day N of the week in the last M weeks, average time between product page views per session, number of clicks on website button B per visit (for an example button B), ratio of cart additions to completed purchases per session, and other features.

Features can be derived based on user profiles, behaviors or attributes (e.g., inferred user interests, user-provided location, user-provided age, etc.). In some examples, specific traits can have a dedicated feature set (e.g., see below for example features that can be used in conjunction with the Predictive LTV feature). Features can be raw features, or transformed and/or aggregated features.

In some examples, feature engineering and/or feature set construction can be implemented by the predictive trait system 220 as a combination of a scheduled daily component and aggregation at training time for computation cost savings. Event stream-based transformations can be expanded to include timestamp information (day of the week, week of the year, month of the year) or activity intervals. In some examples, user profile or user trait data is processed to remove personal identification information (PII). In some examples, categorical data embedding techniques are used to derive embeddings from the raw feature data.

In some examples, the feature generation process described above is implemented by a feature generation system. When multiple personas, views, or IDs for an entity (e.g., a user) are found to be associated with a single canonical ID corresponding to the entity (e.g., user), the feature generation system aggregates feature values for each relevant feature and computes aggregate feature values associated with the canonical ID and/or entity or user. The predictive trait system 220 can then execute predictions or computations at the level of canonical IDs or entities. For example, the predictive trait system 220 predicts the likelihood of a future conversion event (such as a click event or purchase event) associated with a canonical ID and/or a group of merged personas/views/IDs.

In some examples, appropriate feature selection/pruning (e.g., selecting top K features by correlation coefficient, using dimensionality reduction (e.g., via PCA) to decrease the effect of highly correlated features), automatic identification of features likely to contribute to overfitting, and other feature set analysis and transformation steps can be performed by the predictive trait system 220, as part of the training pipeline 304 described below. In some examples, the predictive trait system 220 and the models described below are agnostic to specific marketing domain knowledge. In some examples, the predictive trait system 220 and the models described below use specific marketing domain knowledge, for example as specified by a system user with domain expertise (e.g., a marketer), or by a developer.

In some examples, the data used to build a trait-specific ML model encompasses a time component, and therefore the predictive trait system 220 must define and enforce minimum history requirements (e.g., for event streams used to derive features). The minimum history requirements for such event streams are based on the set of one or more feature window sizes used during the featurization process (e.g., the process of constructing the feature set). The predictive trait system 220 employs user inclusion criteria to ensure that target variables and/or features can be computed: for example, users are included in a training set or development set only if their activity meets a set of predefined thresholds, or based on other automatically tracked measures of user activity. In such examples, user inclusion criteria are based on data size or data volume requirements, and/or on patterns of user activity. In some examples users with sparser activity patterns or no activity can still be included by using a cold start strategy.

In some examples, the predictive trait system 220 trains one trait-specific model for users that have previously performed a target action (or were previously connected to a target event), and one model for users that have not previously performed the target action; the two models are then combined into a unified prediction model. Each of the respective user subpopulations can be required to meet predefined thresholds to guarantee a model can be trained. Such thresholds can be related to subpopulation size, activity levels per user, and/or other predefined user and/or user subpopulation inclusion criteria.

In some examples, when constructing the entries in the training set and/or evaluation set, the predictive trait system 220 derives a label for each example in the training/set based on set of binary labels derived from the occurrence of an event during a target window of time. In some examples, the predictive trait system 220 embeds time information encoded in the event in the label creation process.

In some examples, a predictive trait system 220 uses criteria, characteristics and/or other information provided by the system user in order to select a subpopulation of interest for model training. Additional criteria or logic can be implemented by the predictive trait system 220 to ensure congruence between model training and model inference phases.

In some examples, “training set” is understood in the context of typical ML model development, where a development set is selected and properly split into train/validation/test sets (therefore the training set may refer to a “train/validation” set and a test set may refer to “test/evaluation” or “test/assessment” set). In some examples, properly splitting the development set takes into account temporal dependencies (e.g., corresponding to the time series nature of the event streams, or the tracked user behaviors).

### Model Evaluation Considerations

In some examples, models trained by the predictive trait system 220 are compared against a relevant baseline, using traditional evaluation metrics (e.g., normalized cross entropy, hazard ratio, ROC-AUC, PR-AUC), or other evaluation metrics especially relevant for business lift. In some examples, a baseline is a univariate scaled score based on the most correlated feature/event (e.g., extreme feature selection). In some examples, a model is deployed if its performance measured by a single metric is at least as good as the baseline performance and/or a previous trained model.

In some examples, evaluation metrics are computed separately for choice user subpopulations (e.g., “new Xers”—users new to a target event or taking an action for the first time, “Xers”—corresponding to users associated with a target event or action X, “no-Xers”—corresponding to users who have not been associated with an event or action of interest, “lapsed Xers” such as users who previously took an action but no longer do so, etc.). In some examples, a functional form of the distribution of scores is computed as part of the evaluation metrics suite. In some examples, the size of predicted groups and/or the correlation of model predictions for choice user subpopulations during a feature time window are used as part of evaluating whether the performance of a trained model is superior to that of a baseline model. In some examples, a “replay” feature can be implemented to show the system user the benefit that trait prediction scores for a selected trait would have provided over time, especially in the presence of a long event stream collection for the target trait or event.

### Predictions Service

In some examples, a predictions service 212 of a predictive trait system 220 will run a training pipeline 304, created for example by a training workflow 214. The training pipeline 304 retrieves relevant customer data (e.g., user profile data for members of the training set or training audience, constructed for instance by training workflow 214), from one or more databases or datalakes such as the predictions datalake 310, DB(s) 312, and/or remote storage such as cloud storage. Audience membership data is read or accessed from its local or remote storage. For example, such data is stored by the compute service 206 in the compute bucket 322, which corresponds to cloud storage (e.g., AWS storage such as an Amazon S3 bucket, Google Cloud Storage, Microsoft Azure Storage, etc.) The training pipeline assembles the relevant data for each member of the training set (or training audience) by accessing and combining user profile data and audience membership data. In some examples, the training pipeline 304 reads lean events from the predictions datalake 310. In some examples, the training pipeline 304 reads lifetime value (LTV) event properties (e.g., track event properties), and a latest version of merge tables, from one or more DB(s) 312.

After the training pipeline 304 retrieved the relevant customer data for the trait of interest and the training test of interest, the training pipeline 304 trains a new model (e.g., ML model) corresponding to the trait of interest (e.g., a predictive LTV model, a model for predicting likelihood to purchase, etc.). A trained model for a specific interest can be evaluated by comparing it with a baseline model (e.g., a marketer-provided model, a model constructed with marketer input, etc.). If the predictive trait system 220 automatically assesses that the trained model meets a number of predetermined performance-related thresholds (e.g., accuracy on a held-out set, performance superior to a baseline model on a held-out set, etc.), the trained model can be used for inference.

The predictions service 212 runs an inference pipeline 306 (for example as part of the inference workflow 216). Running an inference pipeline 306 included retrieving a trained trait-specific model and running the model for each member of a test set (e.g., inference audience). In some examples, the test set is created as part of the inference workflow 216, using for example a compute service 206. The test set is stored in local or remote storage (e.g., cloud storage such as cloud compute bucket 322) for the respective compute service. The test set is accessed (read) by the inference pipeline 306. In order to run a trained model on each inference audience member, inference pipeline 306 assembles the relevant data for each inference audience member (e.g., from predictions datalake 310, DB(s) 312, etc.). The inference pipeline 306 reads lean events (e.g., from predictions datalake 310), event properties (e.g., for LTV), and/or latest version of merge tables (e.g., from databases 124).

After the inference pipeline 306 finishes the model run, the predictions service 212 can run a join external ID pipeline 308, which join the results of the inference pipeline (e.g., computed prediction(s) for each member of the inference audience) with external ID tables (e.g., as required by an audience destination service 218). In some examples, the external ID tables are read from storage such as from one or more DB(s) 312, etc. The join external ID pipeline 308 can compute post-inference outputs (e.g., percentiles, stats, model explainability-related quantities, etc.), and/or indicate or mark null trait values for users with low or no activity according to one or more activity-related predetermined thresholds. In some examples, the inference pipeline 306 and join external ID pipeline 308 are part of an inference workflow 216 (see FIG. 2). The inference workflow 216 can upload predictions (e.g., results of the inference pipeline 306) to user profiles and/or destinations within an audience destination service 218.

In some examples, the predictive trait system 220 includes a DB exporter 302, which in turn may include a DB exporter: driver 314, a DB exporter: predictions processor 316 and a DB exporter: status writer 318. The DB exporter: driver 314 triggers an export pipeline (e.g., exporting data from DB(s) 312) for a given or current customer namespace. The respective export pipeline runs on a schedule (e.g., once a day). The DB exporter 302, for example via the DB exporter: driver 314, queries stored customer namespace data, stored for example in the predictions DB 320. Querying stored customer namespace data includes reading their latest timestamp. The predictive trait system 220 (e.g., via the DB exporter 302) also records the creation of a new job. In some examples, the DB exporter: predictions processor 316 queries customer events and/or traits (e.g., from predictions DB 320 or DB(s) 312) incrementally, by date (only new events are processed). In some examples, the DB exporter: predictions processor 316 exports data to a predictions datalake 310. In some examples, the DB exporter: status writer 318 completes the data export process, upserting the latest timestamp for the given or current customer namespace. In some examples, the predictions DB 320 contains customer namespace information, predictive traits and/or trait values, as well as pipeline and data export states. The information stored in the predictions DB 320 is retrieved, updated, or augmented by various workflows and/or pipelines as described above.

In some examples, the storage used by the predictive trait system 220, including the predictions DB 320, the predictions datalake 310, DB(s) 312 and other storage, includes one or more storage types (e.g. Postgres DB, Oracle DB, MySQL DB, Amazon DynamoDB,

MongoDB and other relational and non-relational DBs for the predictions DB 320, an Apache Iceberg (or other solutions for large analytic tables) for predictions datalake 310, BigQuery for DB(s) 312, and other storage types.

In some examples, one or more of the pipelines in the predictive trait system 220 is implemented using a cloud-based machine learning service such as Amazon SageMaker, and a compute service such as AWS Lambda. In some examples, the components and modules of the predictive trait system 220 enable large-scale deployment of models for a broad base of customers (e.g., hundreds of models for thousands of customers).

### Predictive Trait Example: Customer Lifetime Value

The following is a non-limiting example of a core predictive trait, Predicted Customer Lifetime Value (LTV or CLTV), which illustrates how predictive traits are modeled and/or implemented by the predictive trait system 220. Predicted (or Predictive) LTV predicts the future LTV of each user (e.g., a business customer) in a test set or inference audience. LTV corresponds to an estimated dollar amount that each user (e.g., business customer) is likely to spend on a platform over their lifetime (e.g., the duration of their relationship with a business, platform, or other entity using the predictive trait system 220). In some examples, LTV predictions (e.g., dollar amount values, rounded with respect to an example rounding scheme such as nearest dollar or 10 dollars) computed by a LTV-specific trained model are stored in association with the profiles of the users for whom a prediction was made. Use cases for Predicted LTV include campaign optimization, audience optimization, audience discovery, prebuilt traits, audiences, data-driven customer profiling, customer journey optimization, customer lifetime value modeling, digital marketing optimization, reducing churn or increasing retention.

The predictive trait system 220 can use one or more practical formulations for LTV. For example, the predictive trait system 220 can use a partial LTV estimate defined as the expected gross revenue for a given user for a predetermined period of time (e.g., K months, where K=3/6/9/12, etc.). In some examples, the computed expected gross revenue (e.g., the partial LTV estimate) can be used to derive a full LTV estimate (e.g., by using multiplication in the context of an estimated lifetime value). A decay factor (e.g., exponential decay, etc.) can be used as part of the extrapolation computation. Different system users (e.g., businesses) can be associated with different periods of time (e.g., business A would be associated with K=3 months, while business B would be associated with K=6 months.) The predictive trait system 220 can elicit a desired period of time from a system user, and/or estimate a desired period of time by mining and aggregating historical data mapping the interactions of business customers with a specific system user (e.g., business).

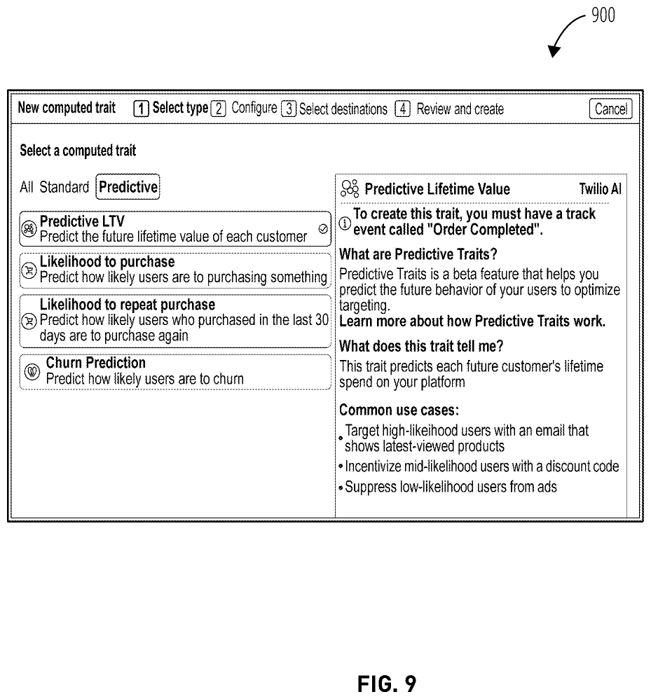

The predictive trait system 220 can use information provided by the system user to configure the predictive LTV trait, such as a track event (see at least FIG. 9 and FIG. 10 for configuration options). In some examples, the predictive trait system 220 constructs and/or deploys a LTV model (e.g., a ML model). In some examples, the predictive trait system 220 uses a training set containing labeled examples, where each example corresponds to a user (e.g., customer of business), and the label corresponds to a customer lifetime value (a LTV score). The labels can be zero and one or more non-zero values (e.g., positive labels). A trained LTV model can then be used to predict the LTV of one or more users in a test set (e.g., inference audience).

In some examples, the predictive trait system 220 includes, as part of the training set and/or set for a LTV model, users with N months of data (e.g., N=6/9/12/etc.). In some examples, a training set is constructed as follows: a subset of unique user ID-associated data from an initial dataset is assigned to the training portion; for each unique user ID, data for a first time window (N1, N2) is included in data used to derive features, and data for a second time window (N2, N3) is included in data used to derive labels. For example, the training portion is split into two windows: features_window: [12 months to 3 months from end date], and labels_window: [3 months to end date]. Training features are computed based on the feature window. The expected label (e.g., expected output) for each user can be derived as the sum of the orders completed by the user in the label window. A similar approach is used to obtain the features and labels associated with the users in the test set.

In some examples, features include one or more of:
f_monetary: the sum of all orders' monetary values per customer in the features window.
f_frequency: the number of orders placed by a customer during in the features window.
f_time_between: average time between orders for a customer in the features window.
f_avg_basket_value: average monetary value of the customer's basket in the features window.
f_recency: time between the first and last orders placed by a customer in the features window.
f_capital_t: time between the first order placed by a customer and the end of the features window.
f_lifespan: customer lifespan.

A system user (e.g., business) can store its transactional data as part of, or associated with, specific events. System users can specify the event(s) to be used by the predictive trait system 220 to source information used to derive features and labels for LTV prediction. Example events of interest include order_completed (e.g., a user completed the order), order_updated, order_refunded, order_cancelled, etc. (see at least FIG. 10). System users can specify an alternative field with revenue and optional currency properties, and predictive trait system 220. Example information obtained from such events and/or fields includes the order total associated with the order_completed event (or equivalent), the ID of the user, the currency or revenue property value, time of the order, or other features.

### Example: Unique LTV Model

In some examples, the LTV model can be a regression model (e.g., a XGBoost regression model). The loss function can be the mean squared log loss, which penalizes the model overestimating the target value more than underestimating it. In some examples, the LTV model can be a probabilistic model that fits a probability distribution onto a set of user-specific data and predicts a LTV score (e.g., using the open-source PyMC-Marketing package). In some examples, the model is a deep learning (DL) model.

### Example: LTV Model Pipeline

In some examples, the predictive trait system 220 uses a multi-step LTV computation pipeline or model. For example, predictive trait system 220 first computes a predicted survival rate based on a churn estimate implemented using a Beta-Geometric/Negative Binomial Distribution (BG/NBD) model and features such as the age of the customer in the dataset, purchase frequency and purchase recency. The predicted survival rate is used for a gamma-gamma model that predicts the expected monetary value of future customer transactions.

### Example: LTV Model Pipeline

The predictive trait system 220 can use alternative multi-step LTV computation pipelines to target specific system needs. For example, building high-quality LTV models requires handling high user variance in LTV labels that can lead to poorly calibrated LTV predictions. A poorly calibrated LTV model can overestimate low LTV predictions and generate values that do not make sense to system users such as businesses. The poorly calibrated LTV model can mistakenly generate small values instead of high values.

An example model pipeline can seek to explicitly handle, for example, likely zero-LTV users (users with a likely LTV of 0) and likely nonzero-LTV users, as seen below.

1. First, the predictive trait system 220 identifies and/or separates likely zero-LTV users (users with a likely LTV of 0) from likely nonzero-LTV users. In some examples, this step can use a supervised classification model (e.g., XGBoost classification). Alternatively, this step can use an unsupervised approach (e.g., a clustering algorithm with a predefined number of target clusters, etc., numClusters=2/3/etc.).

2. Second, a regression model (e.g., XGBoost regression) computes an expected LTV, for example an expected gross revenue value over a period of K months (e.g., K=3). The results can be displayed to the system user separately (e.g. P (X=0) and P (X=x|x>0)), or only retaining P (X=x|x>0).

1. In some examples, the predictive trait system 220 splits the training set from the offset and train a classification model and a regression model on separate subsets of the training set. This training regimen has the advantage of being easy to implement and parallelize.

2. In some examples, the predictive trait system 220 can train the classification model on all (X, y) pairs in the training set (where X corresponds to a training set example and y corresponds to the label of the example). The predictive trait system 220 can train the regression model on the subset of the training data whose corresponding included labels are positive. In some examples, this training regimen can lead to significantly less under-estimation for examples with high LTV values (e.g., as ground truth).

3. In some examples, the predictive trait system 220 can distribute training data between the classification model and the regression model by a) training the classification model on all (X, y) pairs in the training set (where X corresponds to a training set example and y corresponds to the label of the example), b) classify the examples in the training set using the trained classification model and retain only those examples corresponding to non-zero classification labels; c) train the regression model only on the retained examples (e.g. corresponding to positive classification predictions).

In some examples, the ML models use one or more hyperparameters (e.g., number of decision trees and/or maximum tree depth in the case of XGBoost, a Boolean flag indicating whether the majority class should be downsampled or not, etc.). In some examples, the hyperparameters common to the classification and regression model can have the same values (e.g., n_trees=1000, max_depth=5, downsample_majority_class=False, etc.). In some examples, the hyperparameters can be the same for one or both models across system users (e.g., the same parameters are used for business A as for business B), or the classification and/or regression model hyperparameters can be optimized for a given business, or across a set of businesses (e.g., corresponding to a commerce vertical such as clothing retailers, etc.). In some examples, a grid search procedure can be executed at the level of a given system user (e.g., business) to obtain consistent model improvement.

By separating identifying non-zero LTV users from predicting the LTV of non-zero LTV users, the predictive trait system 220 can offer a better experience for system users (e.g., businesses). For example, businesses can target the two cohorts differently, by sending out separate types of promotions to incentivize likelihood to purchase versus likelihood to make big purchases.

### Example: Percentile Mapping Calibration Pipeline

In some examples, the predictive trait system 220 uses a 2-step percentile mapping calibration. At a first step, a first model is trained to predict the most likely percentile associated with an example (e.g., a user). At a second step, a second model is trained to predict a LTV score for each given percentile derived in the first step. The pipeline represented by the first and second model is therefore able to predict a LTV score for each example (e.g., user). The first and/or second model can be XGB models (e.g., classification and/or regression models), decision trees, random forests, and other ML models.

In some examples, the predictive trait system 220 uses a combined approach that employs multiple of the strategies described above, or a combination of their steps. For example, a first model trained to predict the most likely percentile associated with an example can be used to corroborate a classification model trained to identify zero-LTV and non-zero-LTV users. In another example, a combined approach can isolate users with low corresponding levels of activity (e.g., using one or more activity criteria), run multiple strategies described above to compute an estimated LTV, and subsequently proceed to combine the estimates using a pre-determined combination function (e.g., weighted average or mean, etc.).

### Evaluating LTV Models

A system user (e.g., marketer) should be able to rank its customers based on their expected LTV over a reasonably long time frame or over their predicted lifetime. Therefore, predicted LTV should approach the actual LTV for a majority of the users (e.g., customers, business users) in the test set or inference audience. LTV can also be useful in predicting the average LTV for user cohort, which requires the average predicted LTV to be close to the actual LTV over a predetermined time frame. Example evaluation metrics used include mean squared error, mean absolute error, median absolute error, mean squared log error. Additional evaluation metrics can include ranking metrics measuring the quality of the rankings derived from the predicted values: Kendall's tau coefficient, normalized discounted cumulative gains (nDCG) for the top 10% using the quantile as the graded relevance, precision and/or recall for the real top 1%, 10% and 20% within the predicted 1%, 10% and 20%, and other ranking metrics.

Therefore, LTV models can be evaluated using additional custom metrics that seek to identify models exhibiting good calibration and treatment of users likely to have LTV=0. Such metrics include: a custom Kolmogorov-Smirnoff distance (KS-distance) defined as KS-distance (non-zero-labels, non-zero-predictions); |(#non-zero-predictions/#predictions)-(#non-zero-labels/#labels); or a combination thereof.

Trained LTV models can be evaluated with respect to one another, as well with respect to one or more baselines. Baselines can include a prediction model that assumes that average daily spending per customer will be the same during the training window and the prediction window, and uses this assumption and the length of the prediction window to derive an expected gross revenue per customer.

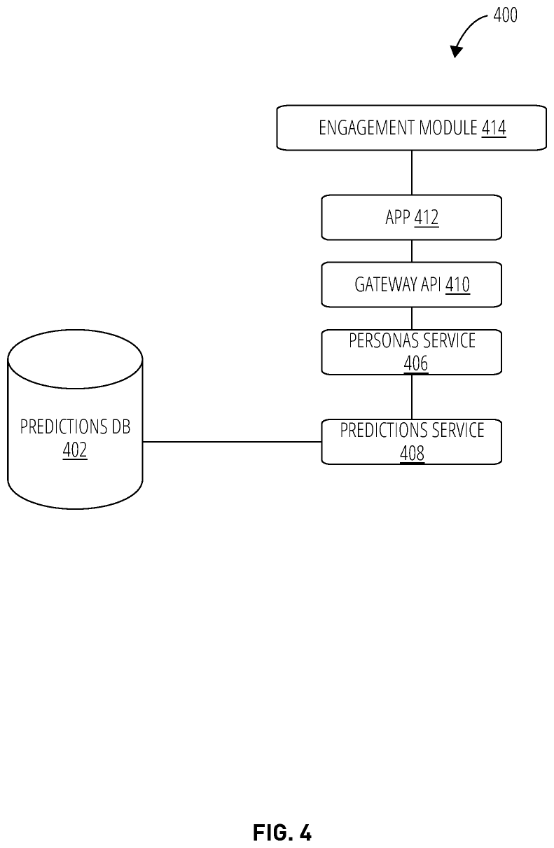

FIG. 4 is a block diagram 400 illustrating a partial view of a predictive trait system 220, according to some examples. The predictive trait system 220 includes an engagement module 414 (e.g., corresponding to the engagement module 204 in FIG. 2). Upon receiving input and/or selection from a system user, the engagement module 414 can initiate the creation of a set of default predictive traits and/or initiate functionality allowing a system user to interact with them, configure and/or create custom predictive traits. In some examples, the engagement module 414 launches an app 412 (e.g., a React app) corresponding to a UI (e.g., a console UI) where system users can interact with predictive traits. The app 412 can perform an API call directed to a gateway API 410 to create computed traits (e.g., propensity to take an action, LTV traits, or other traits). The gateway API 410 can be a GraphQL/REST API.

The gateway API 410 calls in some examples, a personas service 406 (e.g., implemented using a Node.js service). The personas service 406 retrieves, aggregates and stores information about user profiles, accounts and/or activities: for example, a user or customer of a business can have multiple accounts and/or log-ins on one or more devices through which the user interacts with a particular business. Each such account and/or log-in represents a persona of the user. The personas service 406 manages the data associated with user personas. In some examples, the personas service 406 includes or receives input from an identity resolution module that indicates which user personas map to the same user. The personas service 406 can call internal endpoints associated with the predictions service 408 (e.g., corresponding to the predictions services 212 as described at least in FIG. 2 and FIG. 3, implemented in some examples as a Go service, etc.). The predictions service 408 interfaces with the predictions DB 402 (e.g., corresponding to predictions DB 320 detailed in FIG. 3).

In some examples, part or all of the functionality of the app 412 and/or gateway API 410 are encapsulated by the predictive trait UI 208 component in at least FIG. 2.

FIG. 5 is a flowchart illustrating a method 500 as implemented by a predictive trait system 220, according to some examples.

At operation 502, method 500 detects, at a predictive trait UI for predictive trait system 220, a selection of a predictive trait of a plurality of predictive traits, and a selection of a configuration setting for the predictive trait.

At operation 504, method 500 executes, using an orchestrator, one or more of at least: an onboarding flow configured to retrieve user data for a plurality of users (operation 506), a training workflow configured to generate a trained predictive trait model (operation 508), an inference workflow configured to run the trained predictive trait model on a test set comprising one or more users, the trained predictive trait model configured to compute predictive trait values for the one or more users in the test set (operation 510), or a post-inference generation of explanations associated with one of at least the trained predictive trait model, the computed predictive trait values, or the test set (e.g., test users) (operation 512). The generated explanations, including for example the most important features, prediction result summaries, and/or other explanations, can be displayed via the predictive trait UI (operation 514).

FIG. 6 is an illustration 600 of a view of a UI for a predictive trait system 220, according to some examples. In some examples, as part of an onboarding phase, a system user (e.g., marketer) selects one or more user-selectable interface elements in order to choose a “prediction” mode and/or one of a set of traits of interest (e.g., see at least FIG. 9 for further details). In some examples, the system user can request a demo, or fill out a form as part of an onboarding phase.

The predictive trait system 220 can offer a set of core traits, such as likelihood to purchase, likelihood to repeat purchase, predictive LTV (see at least FIG. 4, FIG. 9,) propensity to churn, and other traits. The predictive trait system 220 allows the user to create and customize a custom prediction goal, or a custom trait (see at least FIG. 7).

FIG. 7 is an illustration 700 of trait configuration in a UI for a predictive trait system 220, according to some examples. In some examples, a system user can customize a trait or predictive goal (e.g., an existing one of a set of core traits, a user-created custom goal or trait, etc.). Customization can include selecting an event type (e.g., action, or action type), such as “order_completed,” “add_to_cart,” “page_visit.” In some examples, the selected event type defines an event stream used for sourcing information related to the prediction goal (e.g., see the Predictive LTV discussion in FIG. 3). Creating or customizing a trait or predictive goal can include selecting one or more events (or event types), one or more actions, and/or one or more conditions. Conditions can require or preclude one or more user actions. For example, FIG. 7 shows an example of a system user creating (or customizing) a custom predictive goal by specifying multiple actions of interest. The system user can request a computation of a prediction that a user (e.g., business customer) that performed a first action or action type (e.g., “form_viewed”) at least once, is likely to perform a second action or action type (e.g., “form_submitted”) in a given period of time (e.g., 30 days).

In some examples, a system user can select characteristics for building a training audience (e.g., a training set for the trait-specific prediction model). In some examples, a predictive goal or predictive trait requires a prediction that multiple events or actions will be undertaken during the same future period of time. In some examples, a predictive goal (or trait) corresponds to a prediction of a ranking of multiple events or actions associated with a user (e.g., a customer of a business). In some examples, audience membership, property information, or specific trait values can be used in trait creation. For example, a system user (e.g., a marketer) can select a revenue property in order to create and/or configure a trait or predictive goal (e.g., see FIG. 10).

In some examples, once a trait is created and a trait prediction for a member of a test set (e.g., a user in the inference audience) is computed, the trait prediction is saved to the corresponding user profile stored by the predictive trait system 220. Therefore, the trait is usable by a user profile-associated API. The system can use the trait to build custom audiences, add it to customer journeys, or to send it to destinations (e.g., within the audience destination service 218). Audience building can be based on one or more traits, raw prediction values (e.g., propensity scores), statistics derived based on trait prediction values, such as user percentile cohorts, and other trait-related quantities. The destinations for the trait predictions can be selected by the system user via a UI, as indicated at the top of FIG. 7. The predictive trait system 220 can suggest audience construction mechanisms to a predictive traits user. The predictive trait system 220 can make additional suggestions based on computed trait predictions—for example, the system can automatically select and/or rank one or more destinations for the trait predictions for further user input or selection.

FIG. 8 illustrates a visualization 800 of trait prediction-related data within a UI for a predictive trait system 220, according to some examples. In some examples, a system user selects one or more user-selectable UI elements to choose a percentile to build a cohort (top K % users ranked by the probability that they will undertake the desired action, or convert to the marketer goal expressed for example as a target_event). In some examples, the predictive trait system 220 includes additional visualizations, such as for example a visualization of historical trait values, for example based on various aggregation functions or statistics computed over the population of users for which historical trait-related data is available, etc. In some examples, a visualization of historical trait values for only certain users of interest is be included.

In some examples, a UI for the predictive trait system 220 can include a visualization of the change in the trait prediction values (e.g., propensity scores) for one or more users (e.g., people in the set a customer is interested in). A user's trait prediction value can change periodically (e.g., weekly) based on the user's actions (e.g., interacting with one or more tracked websites). A visualization displayed within a UI for the predictive trait system 220 can show the overall trait prediction value for a set of people periodically changing (e.g., on a weekly basis): an average score for a user population (e.g., the average score varying over time), or track an collective measure of propensity scores (e.g., the propensity to purchase over time) as they change periodically (e.g., from week to week), based on new propensity scores) being computed. In some examples, percentile-level changes (e.g., changes in the top 10% cohort, bottom 10%, etc.) can be visualized. In some examples, visualizations use a min-max candle view.

In some examples, a UI for a predictive trait system 220 includes selected information about trait usage (particular steps in audience construction, journeys, etc.), trait growth and more. In some examples, the UI includes a visualization of data pertaining to the training and evaluation of the trait-specific model (feature information, feature weights, a score indicating prediction quality and other information pertaining to explainable AI functions or modules).

The UI can also include data collection guidelines (either embedded in the UI or available in linked documentation) for customers, in order to improve quality and impact of the predictive trait models.

FIG. 9 is an illustration 900 of trait selection within a UI for a predictive trait system 220, according to some examples. The predictive trait system 220 enables the system user (e.g., a business or marketer) to select, for further configuration and application, a Predictive LTV trait, corresponding to the estimated amount that a user (e.g., business customer) will spend in relation to the business over the lifetime of their relationship. A detailed description of the Predictive LTV trait can be found in FIG. 3.

FIG. 10 is an illustration 1000 of trait configuration within a UI for a predictive trait system 220. The predictive trait system 220 enables the user to configure LTV as a previously selected predictive trait (e.g., “Predictive Lifetime Value”) within the predictive trait UI 208 of the predictive trait system 220. A trait can only be created and/or fully configured once, or multiple times. The created trait can be re-created if deleted. In some examples, the user can select an “order_completed” event, as well as a revenue property. In some examples, a trait can only be created if certain thresholds are met. Such thresholds include data size (or data volume) requirements for a predetermined period of time (e.g., 30 days). Such thresholds ensure that the constructed training set for the model will be large enough to provide a quality trained model. Criteria can include a minimum number of active users that are historically active, or active over a predetermined period of time. The predictive trait UI 208 can display error states indicating the criteria that were not met, or any other reasons a trait cannot be created. Once the trait is created, a trait-specific model is run, trained and/or updated, as described in FIG. 3.

FIG. 11 illustrates a visualization 1100 of trait prediction-related data within a UI for a predictive trait system, according to some examples. In some examples, as seen at least in FIG. 9 and FIG. 10, the trait is Predictive LTV. In some examples, after obtaining trait prediction results for a selected and/or configured trait (here, Predictive LTV), the predictive trait system 220 displays a visualization of user percentile cohorts (e.g., top X % or bottom X %, where X=10/20/50/80/etc.) based on the prediction scores computed for the users of interest. The predictive trait system 220 can also display estimated predicted LTV amounts for the user percentile cohorts. Once the trait (e.g., Predictive LTV) has been computed, a system user of the predictive trait system 220 can use it to build an audience, for example by selecting the user-selectable UI element “Create Audience”. The audience can include currently selected users based on their predicted LTV and it can be used to target personalized messages to the respective users.

FIG. 12 illustrates a visualization 1200 of trait prediction-related data within a UI for a predictive trait system, according to some examples. In some examples, as seen at least in FIG. 9 and FIG. 10, the trait is Predictive LTV. In some examples, after obtaining trait prediction results for a selected and/or configured trait (here, Predictive LTV), the predictive trait system 220 displays a visualization of user percentile cohorts and associated information (e.g., top X % or bottom X %, where X=10/20/50/80/etc.) based on the prediction scores computed for the users of interest.

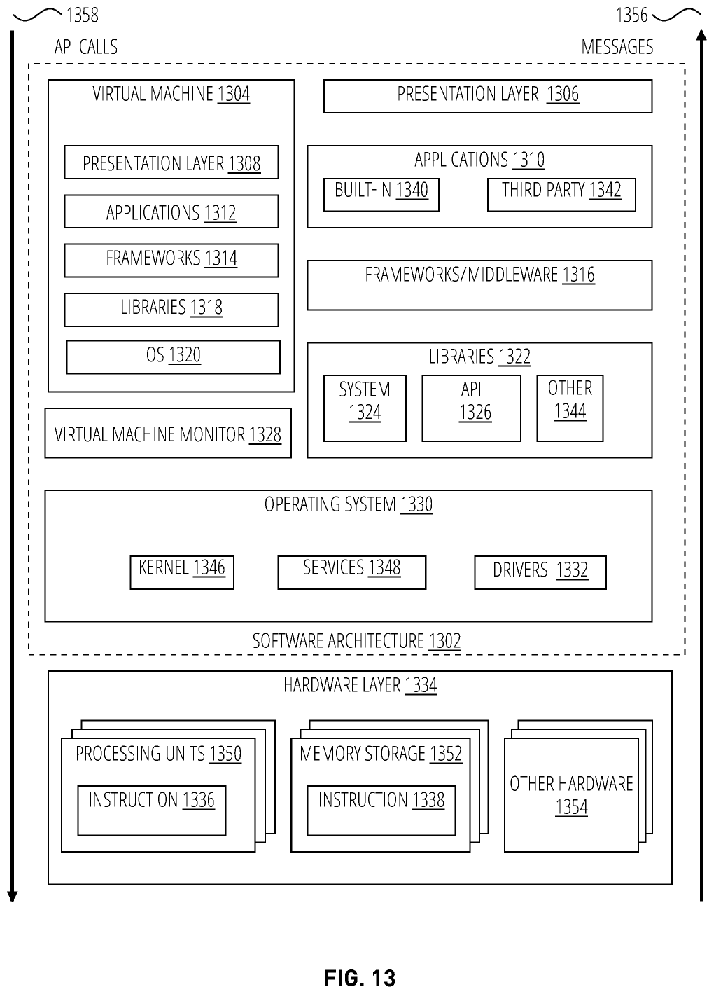

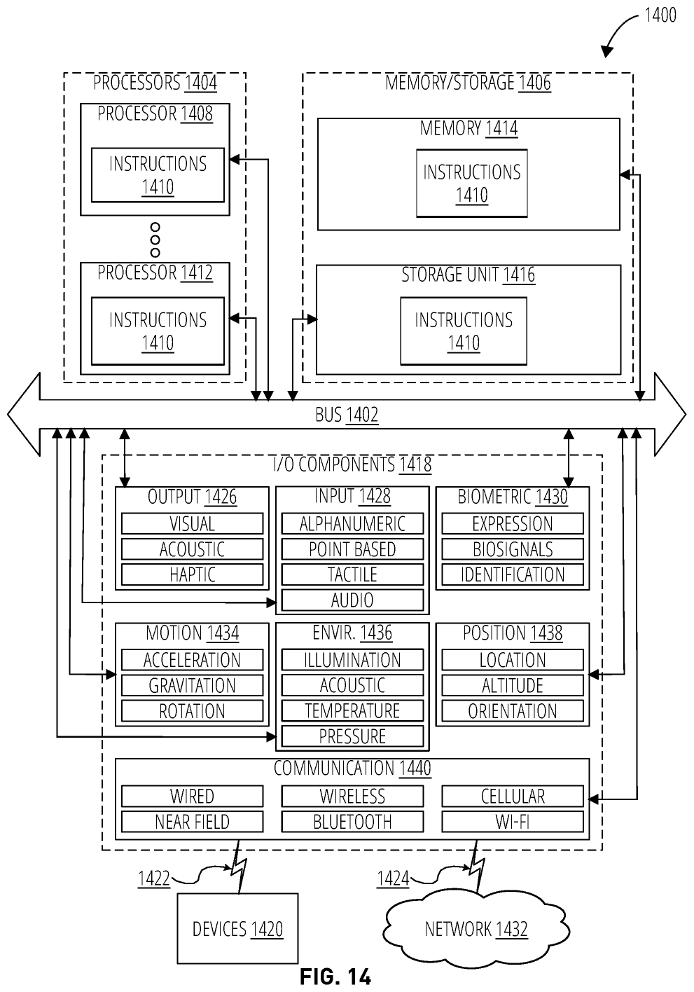

FIG. 13 is a block diagram illustrating an example of a software architecture 1302 that may be installed on a machine, according to some example embodiments. FIG. 13 is merely a non-limiting example of software architecture, and it will be appreciated that many other architectures may be implemented to facilitate the functionality described herein. The software architecture 1302 may be executing on hardware such as a machine 1400 of FIG. 14 that includes, among other things, processors 1404, memory/storage 1406, and input/output (I/O) components 1018. A representative hardware layer 1334 is illustrated and can represent, for example, the machine 1400 of FIG. 14. The representative hardware layer 1334 comprises one or more processing units 1350 having associated executable instructions 1336. The executable instructions 1336 represent the executable instructions of the software architecture 1302. The hardware layer 1334 also includes memory or storage 1052, which also has the executable instructions 1336. The hardware layer 1334 may also comprise other hardware 1354, which represents any other hardware of the hardware layer 1334, such as the other hardware illustrated as part of the machine 1400.

In the example architecture of FIG. 13, the software architecture 1302 may be conceptualized as a stack of layers, where each layer provides particular functionality. For example, the software architecture 1302 may include layers such as an operating system 1330, libraries 1318, frameworks/middleware 1316, applications 1310, and a presentation layer 1308. Operationally, the applications 1310 or other components within the layers may invoke API calls 1358 through the software stack and receive a response, returned values, and so forth (illustrated as messages 1356) in response to the API calls 1358. The layers illustrated are representative in nature, and not all software architectures have all layers. For example, some mobile or special-purpose operating systems may not provide a frameworks/middleware 1316 layer, while others may provide such a layer. Other software architectures may include additional or different layers.

The operating system 1330 may manage hardware resources and provide common services. The operating system 1330 may include, for example, a kernel 1346, services 1348, and drivers 1332. The kernel 1346 may act as an abstraction layer between the hardware and the other software layers. For example, the kernel 1346 may be responsible for memory management, processor management (e.g., scheduling), component management, networking, security settings, and so on. The services 1348 may provide other common services for the other software layers. The drivers 1332 may be responsible for controlling or interfacing with the underlying hardware. For instance, the drivers 1332 may include display drivers, camera drivers, Bluetooth® drivers, flash memory drivers, serial communication drivers (e.g., Universal Serial Bus (USB) drivers), Wi-Fi® drivers, audio drivers, power management drivers, and so forth depending on the hardware configuration.

The libraries 1318 may provide a common infrastructure that may be utilized by the applications 1310 and/or other components and/or layers. The libraries 1318 typically provide functionality that allows other software modules to perform tasks in an easier fashion than by interfacing directly with the underlying operating system 1330 functionality (e.g., kernel 1346, services 1348, or drivers 1332). The libraries 1318 may include system libraries 1318 (e.g., C standard library) that may provide functions such as memory allocation functions, string manipulation functions, mathematic functions, and the like. In addition, the libraries 1318 may include API libraries 1028 such as media libraries (e.g., libraries to support presentation and manipulation of various media formats such as MPEG4, H.264, MP3, AAC, AMR, JPG, and PNG), graphics libraries (e.g., an OpenGL framework that may be used to render 2D and 3D graphic content on a display), database libraries (e.g., SQLite that may provide various relational database functions), web libraries (e.g., WebKit that may provide web browsing functionality), and the like. The libraries 1318 may also include a wide variety of other libraries 1322 to provide many other APIs to the applications and other software components/modules.

The frameworks 1314 (also sometimes referred to as middleware) may provide a higher-level common infrastructure that may be utilized by the applications 1310 or other software components/modules. For example, the frameworks 1314 may provide various graphical user interface functions, high-level resource management, high-level location services, and so forth. The frameworks 1314 may provide a broad spectrum of other APIs that may be utilized by the applications 1310 and/or other software components/modules, some of which may be specific to a particular operating system or platform.

The applications 1310 include built-in applications 1340 and/or third-party applications 1342. Examples of representative built-in applications 1340 may include, but are not limited to, a home application, a contacts application, a browser application, a book reader application, a location application, a media application, a messaging application, or a game application.

The third-party applications 1342 may include any of the built-in applications 1340, as well as a broad assortment of other applications. In a specific example, the third-party applications 1342 (e.g., an application developed using the Android™ or iOS™ software development kit (SDK) by an entity other than the vendor of the particular platform) may be mobile software running on a mobile operating system such as iOS™, Android™, or other mobile operating systems. In this example, the third-party applications 1342 may invoke the API calls 1358 provided by the mobile operating system such as the operating system 1330 to facilitate functionality described herein.

The applications 1310 may utilize built-in operating system functions, libraries (e.g., system libraries 1324, API libraries 1326, and other libraries 1344), or frameworks/middleware 1316 to create user interfaces to interact with users of the system. Alternatively, or additionally, in some systems, interactions with a user may occur through a presentation layer, such as the presentation layer 1308. In these systems, the application/module “logic” can be separated from the aspects of the application/module that interact with the user.

Some software architectures utilize virtual machines. In the example of FIG. 13, this is illustrated by a virtual machine 1304. The virtual machine 1304 creates a software environment where applications/modules can execute as if they were executing on a hardware machine. The virtual machine 1304 is hosted by a host operating system (e.g., the operating system 1330) and typically, although not always, has a virtual machine monitor 1328, which manages the operation of the virtual machine 1304 as well as the interface with the host operating system (e.g., the operating system 1330). A software architecture executes within the virtual machine 1304, such as an operating system 1330, libraries 1318, frameworks/middleware 1316, applications 1312, or a presentation layer 1308. These layers of software architecture executing within the virtual machine 1304 can be the same as corresponding layers previously described or may be different.

FIG. 14 is a block diagram illustrating components of a machine 1400, according to some example embodiments, able to read instructions from a machine-readable medium (e.g., a machine-readable storage medium) and perform any one or more of the methodologies discussed herein. Specifically, FIG. 14 shows a diagrammatic representation of the machine 1400 in the example form of a computer system, within which instructions 1410 (e.g., software, a program, an application, an applet, an app, or other executable code) for causing the machine 1400 to perform any one or more of the methodologies discussed herein may be executed. As such, the instructions 1410 may be used to implement modules or components described herein. The instructions 1410 transform the general, non-programmed machine 1400 into a particular machine 1400 to carry out the described and illustrated functions in the manner described. In alternative embodiments, the machine 1400 operates as a standalone device or may be coupled (e.g., networked) to other machines. In a networked deployment, the machine 1400 may operate in the capacity of a server machine or a client machine in a server-client network environment, or as a peer machine in a peer-to-peer (or distributed) network environment. The machine 1400 may comprise, but not be limited to, a server computer, a client computer, a personal computer (PC), a tablet computer, a laptop computer, a netbook, a personal digital assistant (PDA), an entertainment media system, a cellular telephone, a smart phone, a mobile device, a wearable device (e.g., a smart watch), other smart devices, a web appliance, a network router, a network switch, a network bridge, or any machine capable of executing the instructions 1410, sequentially or otherwise, that specify actions to be taken by machine 1400. Further, while only a single machine 1400 is illustrated, the term “machine” shall also be taken to include a collection of machines that individually or jointly execute the instructions 1410 to perform any one or more of the methodologies discussed herein.

The machine 1400 may include processors 1404, memory memory/storage 1406, and I/O components 1418, which may be configured to communicate with each other such as via a bus 1402. The memory/storage 1406 may include a memory 1414, such as a main memory, or other memory storage, and a storage unit 1416, both accessible to the processors 1404 such as via the bus 1402. The storage unit 1416 and memory 1414 store the instructions 1410 embodying any one or more of the methodologies or functions described herein. The instructions 1410 may also reside, completely or partially, within the memory 1414 within the storage unit 1416, within at least one of the processors 1404 (e.g., within the processor's cache memory), or any suitable combination thereof, during execution thereof by the machine 1400. Accordingly, the memory 1414, the storage unit 1416, and the memory of processors 1404 are examples of machine-readable media.

The I/O components 1418 may include a wide variety of components to receive input, provide output, produce output, transmit information, exchange information, capture measurements, and so on. The specific I/O components 1418 that are included in a particular machine 1400 will depend on the type of machine. For example, portable machines such as mobile phones will likely include a touch input device or other such input mechanisms, while a headless server machine will likely not include such a touch input device. It will be appreciated that the I/O components 1418 may include many other components that are not shown in FIG. 11. The I/O components 1418 are grouped according to functionality merely for simplifying the following discussion and the grouping is in no way limiting. In various example embodiments, the I/O components 1418 may include output components 1426 and input components 1428. The output components 1426 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 1428 may include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or other pointing instrument), tactile input components (e.g., a physical button, a touch screen that provides location and/or force of touches or touch gestures, or other tactile input components), audio input components (e.g., a microphone), and the like.

In further example embodiments, the I/O components 1418 may include biometric components 1430, motion components 1434, environmental environment components 1436, or position components 1438 among a wide array of other components. For example, the biometric components 1430 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 1434 may include acceleration sensor components (e.g., accelerometer), gravitation sensor components, rotation sensor components (e.g., gyroscope), and so forth. The environment components 1436 may include, for example, illumination sensor components (e.g., photometer), temperature sensor components (e.g., one or more thermometer that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 1438 may include location sensor components (e.g., a Global Position system (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 1418 may include communication components 1440 operable to couple the machine 1400 to a network 1432 or devices 1420 via coupling 1422 and coupling 1424 respectively. For example, the communication components 1440 may include a network interface component or other suitable device to interface with the network 1432. In further examples, communication components 1440 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 1420 may be another machine or any of a wide variety of peripheral devices (e.g., a peripheral device coupled via a Universal Serial Bus (USB)).

Moreover, the communication components 1440 may detect identifiers or include components operable to detect identifiers. For example, the communication components 1440 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 1440, such as, location via Internet Protocol (IP) geo-location, location via Wi-Fi® signal triangulation, location via detecting a NFC beacon signal that may indicate a particular location, and so forth.

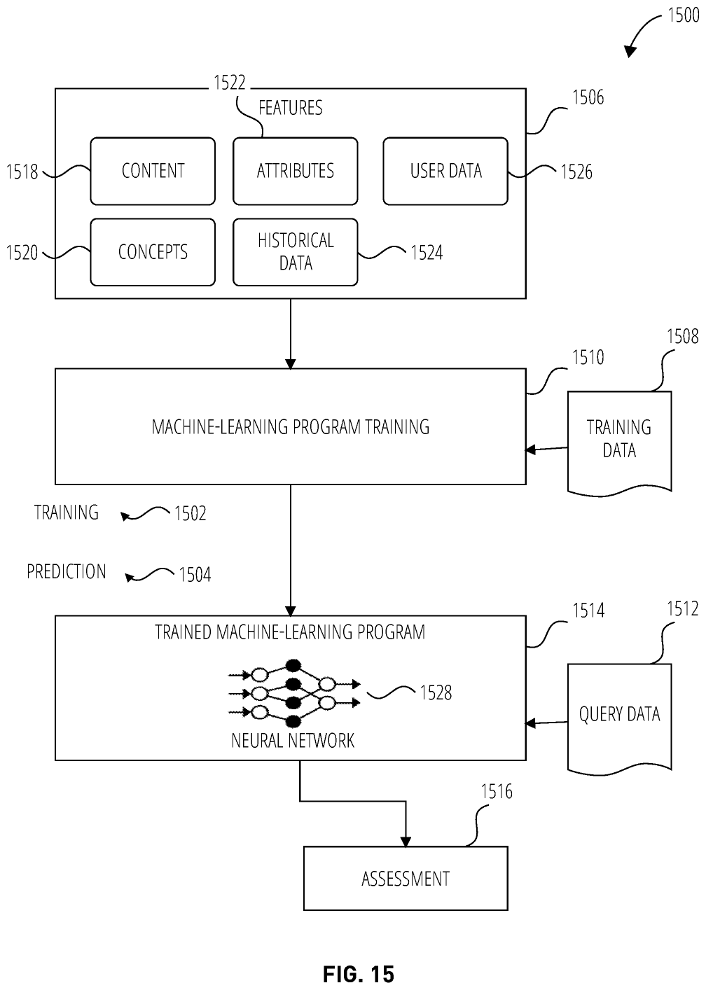

FIG. 15 is a block diagram showing a machine-learning program 1500 according to some examples. The machine-learning programs 1500, also referred to as machine-learning algorithms or tools, are used as part of the predictive trait system 220 system described herein, for instance to perform operations of trait-specific machine learning models (see FIG. 2 and FIG. 3).

Machine learning is a field of study that gives computers the ability to learn without being explicitly programmed. Machine learning explores the study and construction of algorithms, also referred to herein as tools, that may learn from or be trained using existing data and make predictions about or based on new data. Such machine-learning tools operate by building a model from example training data 1508 in order to make data-driven predictions or decisions expressed as outputs or assessments (e.g., assessment 1516). Although examples are presented with respect to a few machine-learning tools, the principles presented herein may be applied to other machine-learning tools.

In some examples, different machine-learning tools may be used. For example, Logistic Regression (LR), Naive-Bayes, Random Forest (RF), Gradient Boosted Decision Trees (GBDT), neural networks (NN), matrix factorization, and Support Vector Machines (SVM) tools may be used. In some examples, one or more ML paradigms may be used: binary or n-ary classification, semi-supervised learning, etc. In some examples, time-to-event (TTE) data will be used during model training. In some examples, a hierarchy or combination of models (e.g. stacking, bagging) may be used.

Two common types of problems in machine learning are classification problems and regression problems. Classification problems, also referred to as categorization problems, aim at classifying items into one of several category values (for example, is this object an apple or an orange?). Regression algorithms aim at quantifying some items (for example, by providing a value that is a real number).

The machine-learning program 1500 supports two types of phases, namely a training phases 1502 and prediction phases 1504. In training phases 1502, supervised learning, unsupervised or reinforcement learning may be used. For example, the machine-learning program 1500 (1) receives features 1506 (e.g., as structured or labeled data in supervised learning) and/or (2) identifies features 1506 (e.g., unstructured or unlabeled data for unsupervised learning) in training data 1508 In prediction phases 1504, the machine-learning program 1500 uses the features 1506 for analyzing query data 1512 to generate outcomes or predictions, as examples of an assessment 1516.

In the training phase 1502, feature engineering is used to identify features 1506 and may include identifying informative, discriminating, and independent features for the effective operation of the machine-learning program 1500 in pattern recognition, classification, and regression. In some examples, the training data 1508 includes labeled data, which is known data for pre-identified features 1506 and one or more outcomes. Each of the features 1506 may be a variable or attribute, such as individual measurable property of a process, article, system, or phenomenon represented by a data set (e.g., the training data 1508). Features 1506 may also be of different types, such as numeric features, strings, and graphs, and may include one or more of content 1518, concepts 1520, attributes 1522, historical data 1524 and/or user data 1526, merely for example.

In training phases 1502, the machine-learning program 1500 uses the training data 1508 to find correlations among the features 1506 that affect a predicted outcome or assessment 1516.

With the training data 1508 and the identified features 1506, the machine-learning program 1500 is trained during the training phase 1502 at machine-learning program training 1510. The machine-learning program 1500 appraises values of the features 1506 as they correlate to the training data 1508. The result of the training is the trained machine-learning program 1514 (e.g., a trained or learned model).

Further, the training phases 1502 may involve machine learning, in which the training data 1508 is structured (e.g., labeled during preprocessing operations), and the trained machine-learning program 1514 implements a relatively simple neural network 1528 (or one of other machine learning models, as described herein) capable of performing, for example, classification and clustering operations. In other examples, the training phase 1502 may involve deep learning, in which the training data 1508 is unstructured, and the trained machine-learning program 1514 implements a deep neural network 1528 that is able to perform both feature extraction and classification/clustering operations.

A neural network 1528 generated during the training phase 1502, and implemented within the trained machine-learning program 1514, may include a hierarchical (e.g., layered) organization of neurons. For example, neurons (or nodes) may be arranged hierarchically into a number of layers, including an input layer, an output layer, and multiple hidden layers. The layers within the neural network 1528 can have one or many neurons, and the neurons operationally compute a small function (e.g., activation function). For example, if an activation function generates a result that transgresses a particular threshold, an output may be communicated from that neuron (e.g., transmitting neuron) to a connected neuron (e.g., receiving neuron) in successive layers. Connections between neurons also have associated weights, which define the influence of the input from a transmitting neuron to a receiving neuron.

In some examples, the neural network 1528 may also be one of a number of different types of neural networks, including a single-layer feed-forward network, an Artificial Neural Network (ANN), a Recurrent Neural Network (RNN), a symmetrically connected neural network, and unsupervised pre-trained network, a Convolutional Neural Network (CNN), or a Recursive Neural Network (RNN), merely for example.

During prediction phases 1504 the trained machine-learning program 1514 is used to perform an assessment. Query data 1512 is provided as an input to the trained machine-learning program 1514, and the trained machine-learning program 1514 generates the assessment 1516 as output, responsive to receipt of the query data 1512.

### EXAMPLES

Example 1 is a system comprising: at least one processor; at least one memory component storing instructions that, when executed by the at least one processor, cause the at least one processor to perform operations, the operations comprising: detecting, at a predictive trait user interface (UI), a selection of a predictive trait of a plurality of predictive traits and a selection of a configuration setting for the predictive trait; executing, using an orchestrator, one or more of at least: an onboarding flow configured to retrieve user data for a plurality of users; a training workflow configured to generate a trained predictive trait model; an inference workflow configured to run the trained predictive trait model on a test set comprising one or more users, the trained predictive trait model configured to compute predictive trait values for the one or more users in the test set; and generating explanations associated with one of at least the trained predictive trait model, the computed predictive trait values, or the test set; and displaying, at the predictive trait UI, the generated explanations.

In Example 2, the subject matter of Example 1 includes, wherein the configuration setting is associated with one of at least an event type configuration, a condition configuration, a time window configuration, a training audience configuration, or a test audience configuration.

In Example 3, the subject matter of Examples 1-2 includes, wherein the training workflow is configured to: select a set of users of the plurality of users, each user in the set of users being associated with corresponding user data determined to meet a data volume requirement; generate, based on the set of users and the user data, a training set, each entry in the training set comprising a user, a feature set and a label associated with a predictive trait value; and generating, using the training set, a trained predictive trait model.

In Example 4, the subject matter of Examples 1-3 includes, wherein the inference workflow is further configured to: select a set of users of the plurality of users, each user in the set of users being associated with corresponding user data determined to meet a data volume requirement; generate the test set based on the set of users and the user data, wherein each entry in the test set comprises a user and a feature set.

In Example 5, the subject matter of Examples 1-4 includes, wherein generating explanations comprises one or more of at least: generating feature importance explanations indicating relative importance of features in generating the trained predictive trait model; and computing percentile statistics corresponding to a distribution of the computed predictive trait values over a population of users.

In Example 6, the subject matter of Examples 1-5 includes, wherein the operations further comprise: synchronizing the computed predictive trait values for the test set of users with user profiles stored by an audience management service; receiving, at the predictive trait UI, a user selection of one or more destinations within the audience management service; transmitting the computed predictive trait values to the one or more destinations to enable the generating of an audience, wherein the generating of the audience comprises profiling users in the test set of users based on the predictive trait.

In Example 7, the subject matter of Examples 1-6 includes, wherein the predictive trait UI further provides selectable UI elements enabling configuring a custom predictive trait, the configuring comprising: specifying a condition requiring or precluding a first user action of a set of recordable user actions; configuring a time window indicating a time period relative to the first user action being recorded; specifying a second user action of a set of recordable user actions, the value of the custom predictive trait corresponding to a Boolean flag corresponding to the second user action being recorded during the time window.

In Example 8, the subject matter of Examples 2-7 includes, wherein: the selected predictive trait is a predictive lifetime value (LTV) trait; the configuration setting is associated with the event type configuration; and the operations further comprise detecting a user selection of a completed order event setting, each completed order event being associated with one or more of a recorded monetary value or a timestamp.

In Example 9, the subject matter of Example 8 includes, wherein generating a predictive trait model for the predictive LTV trait comprises: training a first model to predict a likelihood that a user is a zero-LTV user or a non-zero-LTV user; training a second model to predict a LTV score, over a prediction time period, for each user with an associated likelihood of being a non-zero-LTV user that transgresses a predetermined threshold.

In Example 10, the subject matter of Example 9 includes, wherein: the first model is trained on the training set; and the second model is trained on a subset of the training set, each label in the subset of the training set corresponding to a non-zero value.

In Example 11, the subject matter of Examples 9-10 includes, wherein: the first model is trained on the training set; the second model is trained on a subset of the training set, wherein: the first model is used to predict a label for each example in the training set; each example in the subset of the training set has an associated label predicted by the first model, the associated label corresponding to a non-zero value.

Example 12 is at least one non-transitory, machine-readable medium including instructions that, when executed by processing circuitry, cause the processing circuitry to perform operations to implement of any of Examples 1-11.

Example 13 is an apparatus comprising means to implement any of Examples 1-11.

Example 14 is a method to implement any of Examples 1-11.

### Glossary

“CARRIER SIGNAL” in this context refers to any intangible medium that is capable of storing, encoding, or carrying instructions for execution by the machine, and includes digital or analog communications signals or other intangible medium to facilitate communication of such instructions. Instructions may be transmitted or received over the network using a transmission medium via a network interface device and using any one of a number of well-known transfer protocols.

“CLIENT DEVICE” in this context refers to any machine that interfaces to a communications network to obtain resources from one or more server systems or other client devices. A client device may be, but is not limited to, a mobile phone, desktop computer, laptop, portable digital assistants (PDAs), smart phones, tablets, ultra books, netbooks, laptops, multi-processor systems, microprocessor-based or programmable consumer electronics, game consoles, set-top boxes, or any other communication device that a user may use to access a network.

“COMMUNICATIONS NETWORK” in this context refers to one or more portions of a network that may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, a network or a portion of a network may include a wireless or cellular network and the coupling may be a Code Division Multiple Access (CDMA) connection, a Global System for Mobile communications (GSM) connection, or other type of cellular or wireless coupling. In this example, the coupling may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard setting organizations, other long range protocols, or other data transfer technology.

“MACHINE-READABLE MEDIUM” in this context refers to a component, device or other tangible media able to store instructions and data temporarily or permanently and may include, but is not be limited to, random-access memory (RAM), read-only memory (ROM), buffer memory, flash memory, optical media, magnetic media, cache memory, other types of storage (e.g., Erasable Programmable Read-Only Memory (EEPROM)) and/or any suitable combination thereof. The term “machine-readable medium” should be taken to include a single medium or multiple media (e.g., a centralized or distributed database, or associated caches and servers) able to store instructions. The term “machine-readable medium” shall also be taken to include any medium, or combination of multiple media, that is capable of storing instructions (e.g., code) for execution by a machine, such that the instructions, when executed by one or more processors of the machine, cause the machine to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

“COMPONENT” in this context refers to a device, physical entity or logic having boundaries defined by function or subroutine calls, branch points, application program interfaces (APIs), or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components. A “hardware component” is a tangible unit capable of performing certain operations and may be configured or arranged in a certain physical manner. In various example embodiments, one or more computer systems (e.g., a standalone computer system, a client computer system, or a server computer system) or one or more hardware components of a computer system (e.g., a processor or a group of processors) may be configured by software (e.g., an application or application portion) as a hardware component that operates to perform certain operations as described herein. A hardware component may also be implemented mechanically, electronically, or any suitable combination thereof. For example, a hardware component may include dedicated circuitry or logic that is permanently configured to perform certain operations. A hardware component may be a special-purpose processor, such as a Field-Programmable Gate Array (FPGA) or an Application Specific Integrated Circuit (ASIC). A hardware component may also include programmable logic or circuitry that is temporarily configured by software to perform certain operations. For example, a hardware component may include software executed by a general-purpose processor or other programmable processor. Once configured by such software, hardware components become specific machines (or specific components of a machine) uniquely tailored to perform the configured functions and are no longer general-purpose processors. It will be appreciated that the decision to implement a hardware component mechanically, in dedicated and permanently configured circuitry, or in temporarily configured circuitry (e.g., configured by software) may be driven by cost and time considerations. Accordingly, the phrase “hardware component” (or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware components are temporarily configured (e.g., programmed), each of the hardware components need not be configured or instantiated at any one instance in time. For example, where a hardware component comprises a general-purpose processor configured by software to become a special-purpose processor, the general-purpose processor may be configured as respectively different special-purpose processors (e.g., comprising different hardware components) at different times. Software accordingly configures a particular processor or processors, for example, to constitute a particular hardware component at one instance of time and to constitute a different hardware component at a different instance of time. Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses) between or among two or more of the hardware components. In embodiments in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information). The various operations of example methods described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions described herein. As used herein, “processor-implemented component” refers to a hardware component implemented using one or more processors. Similarly, the methods described herein may be at least partially processor-implemented, with a particular processor or processors being an example of hardware. For example, at least some of the operations of a method may be performed by one or more processors or processor-implemented components. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an Application Program Interface (API)). The performance of certain of the operations may be distributed among the processors, not only residing within a single machine, but deployed across a number of machines. In some example embodiments, the processors or processor-implemented components may be located in a single geographic location (e.g., within a home environment, an office environment, or a server farm). In other example embodiments, the processors or processor-implemented components may be distributed across a number of geographic locations.

“PROCESSOR” in this context refers to any circuit or virtual circuit (a physical circuit emulated by logic executing on an actual processor) that manipulates data values according to control signals (e.g., “commands”, “op codes”, “machine code”, etc.) and which produces corresponding output signals that are applied to operate a machine. A processor may, for example, be a Central Processing Unit (CPU), a Reduced Instruction Set Computing (RISC) processor, a Complex Instruction Set Computing (CISC) processor, a Graphics Processing Unit (GPU), a Digital Signal Processor (DSP), an Application Specific Integrated Circuit (ASIC), a Radio-Frequency Integrated Circuit (RFIC) or any combination thereof. A processor may further be a multi-core processor having two or more independent processors (sometimes referred to as “cores”) that may execute instructions contemporaneously.

“TIMESTAMP” in this context refers to a sequence of characters or encoded information identifying when a certain event occurred, for example giving date and time of day, sometimes accurate to a small fraction of a second.

“TIME DELAYED NEURAL NETWORK (TDNN)” in this context, a TDNN is an artificial neural network architecture whose primary purpose is to work on sequential data. An example would be converting continuous audio into a stream of classified phoneme labels for speech recognition.

“BI-DIRECTIONAL LONG-SHORT TERM MEMORY (BLSTM)” in this context refers to a recurrent neural network (RNN) architecture that remembers values over arbitrary intervals. Stored values are not modified as learning proceeds. RNNs allow forward and backward connections between neurons. BLSTM are well-suited for the classification, processing, and prediction of time series, given time lags of unknown size and duration between events.

Throughout this specification, plural instances may implement resources, components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components.

As used herein, the term “or” may be construed in either an inclusive or exclusive sense. The terms “a” or “an” should be read as meaning “at least one,” “one or more,” or the like. The presence of broadening words and phrases such as “one or more,” “at least,” “but not limited to,” or other like phrases in some instances shall not be read to mean that the narrower case is intended or required in instances where such broadening phrases may be absent. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. The specification and drawings are, accordingly, to be regarded in an illustrative rather than a restrictive sense.

It will be understood that changes and modifications may be made to the disclosed embodiments without departing from the scope of the present disclosure. These and other changes or modifications are intended to be included within the scope of the present disclosure.

What is claimed is:

1. A system comprising:
at least one processor;
at least one memory component storing instructions that, when executed by the at least one processor, cause the at least one processor to perform operations, the operations comprising:
detecting, at a predictive trait user interface (UI), a selection of a predictive trait of a plurality of predictive traits and a selection of a configuration setting for the predictive trait;
executing, using an orchestrator, one or more of at least:
an onboarding flow configured to retrieve user data for a plurality of users;
a training workflow configured to generate a trained predictive trait model;
an inference workflow configured to run the trained predictive trait model on a test set comprising one or more users, the trained predictive trait model configured to compute predictive trait values for the one or more users in the test set; and
generating explanations associated with one of at least the trained predictive trait model, the computed predictive trait values, or the test set; and
displaying, at the predictive trait UI, the generated explanations.

2. The system of claim 1, wherein the configuration setting is associated with one of at least an event type configuration, a condition configuration, a time window configuration, a training audience configuration, or a test audience configuration.

3. The system of claim 1, wherein the training workflow is configured to:
select a set of users of the plurality of users, each user in the set of users being associated with corresponding user data determined to meet a data volume requirement;
generate, based on the set of users and the user data, a training set, each entry in the training set comprising a user, a feature set and a label associated with a predictive trait value; and
generating, using the training set, a trained predictive trait model.

4. The system of claim 1, wherein the inference workflow is further configured to:
select a set of users of the plurality of users, each user in the set of users being associated with corresponding user data determined to meet a data volume requirement;
generate the test set based on the set of users and the user data, wherein each entry in the test set comprises a user and a feature set.

5. The system of claim 1, wherein generating explanations comprises one or more of at least:
generating feature importance explanations indicating relative importance of features in generating the trained predictive trait model; and
computing percentile statistics corresponding to a distribution of the computed predictive trait values over a population of users.

6. The system of claim 1, wherein the operations further comprise:
synchronizing the computed predictive trait values for the test set of users with user profiles stored by an audience management service;
receiving, at the predictive trait UI, a user selection of one or more destinations within the audience management service;
transmitting the computed predictive trait values to the one or more destinations to enable the generating of an audience, wherein the generating of the audience comprises profiling users in the test set of users based on the predictive trait.

7. The system of claim 1, wherein the predictive trait UI further provides selectable UI elements enabling configuring a custom predictive trait, the configuring comprising:
specifying a condition requiring or precluding a first user action of a set of recordable user actions;
configuring a time window indicating a time period relative to the first user action being recorded;
specifying a second user action of a set of recordable user actions, the value of the custom predictive trait corresponding to a Boolean flag corresponding to the second user action being recorded during the time window.

8. The system of claim 2, wherein:
the selected predictive trait is a predictive lifetime value (LTV) trait;
the configuration setting is associated with the event type configuration; and
the operations further comprise detecting a user selection of a completed order event setting, each completed order event being associated with one or more of a recorded monetary value or a timestamp.

9. The system of claim 8, wherein generating a predictive trait model for the predictive LTV trait comprises:
training a first model to predict a likelihood that a user is a zero-LTV user or a non-zero-LTV user;
training a second model to predict a LTV score, over a prediction time period, for each user with an associated likelihood of being a non-zero-LTV user that transgresses a predetermined threshold.

10. The system of claim 9, wherein:
the first model is trained on the training set; and
the second model is trained on a subset of the training set, each label in the subset of the training set corresponding to a non-zero value.

11. The system of claim 9, wherein:
the first model is trained on the training set;
the second model is trained on a subset of the training set, wherein:
the first model is used to predict a label for each example in the training set;
each example in the subset of the training set has an associated label predicted by the first model, the associated label corresponding to a non-zero value.

12. A method comprising:
detecting, at a predictive trait user interface (UI), a selection of a predictive trait of a plurality of predictive traits and a selection of a configuration setting for the predictive trait;
executing, using an orchestrator, one or more of at least:
an onboarding flow configured to retrieve user data for a plurality of users;
a training workflow configured to generate a trained predictive trait model;
an inference workflow configured to run the trained predictive trait model on a test set comprising one or more users, the trained predictive trait model configured to compute predictive trait values for the one or more users in the test set; and
generating explanations associated with one of at least the trained predictive trait model, the computed predictive trait values, or the test set; and
displaying, at the predictive trait UI, the generated explanations.

13. The method of claim 12, wherein the configuration setting is associated with one of at least an event type configuration, a condition configuration, a time window configuration, a training audience configuration, or a test audience configuration.

14. The method of claim 12, wherein the training workflow is configured to:
select a set of users of the plurality of users, each user in the set of users being associated with corresponding user data determined to meet a data volume requirement;
generate, based on the set of users and the user data, a training set, each entry in the training set comprising a user, a feature set and a label associated with a predictive trait value; and
generating, using the training set, a trained predictive trait model.

15. The method of claim 12, wherein the inference workflow is further configured to:
select a set of users of the plurality of users, each user in the set of users being associated with corresponding user data determined to meet a data volume requirement;
generate the test set based on the set of users and the user data, wherein each entry in the test set comprises a user and a feature set.

16. The method of claim 12, wherein generating explanations comprises one or more of at least:
generating feature importance explanations indicating relative importance of features in generating the trained predictive trait model; and
computing percentile statistics corresponding to a distribution of the computed predictive trait values over a population of users.

17. The method of claim 12, further comprising:
synchronizing the computed predictive trait values for the test set of users with user profiles stored by an audience management service;
receiving, at the predictive trait UI, a user selection of one or more destinations within the audience management service;
transmitting the computed predictive trait values to the one or more destinations to enable the generating of an audience, wherein the generating of the audience comprises profiling users in the test set of users based on the predictive trait.

18. The method of claim 12, wherein the predictive trait UI further provides selectable UI elements enabling configuring a custom predictive trait, the configuring comprising:
specifying a condition requiring or precluding a first user action of a set of recordable user actions;
configuring a time window indicating a time period relative to the first user action being recorded;
specifying a second user action of a set of recordable user actions, the value of the custom predictive trait corresponding to a Boolean flag corresponding to the second user action being recorded during the time window.

19. The method of claim 13, wherein:
the selected predictive trait is a predictive lifetime value (LTV) trait;
the configuration setting is associated with the event type configuration; and
the method further comprises detecting a user selection of a completed order event setting, each completed order event being associated with one or more of a recorded monetary value or a timestamp.

20. A non-transitory computer-readable storage medium, the computer-readable storage medium including instructions that when executed by a computer, cause the computer to:
detect, at a predictive trait user interface (UI), a selection of a predictive trait of a plurality of predictive traits and a selection of a configuration setting for the predictive trait;
execute, using an orchestrator, one or more of at least:
an onboarding flow configured to retrieve user data for a plurality of users;
a training workflow configured to generate a trained predictive trait model;
an inference workflow configured to run the trained predictive trait model on a test set comprising one or more users, the trained predictive trait model configured to compute predictive trait values for the one or more users in the test set; and
generate explanations associated with one of at least the trained predictive trait model, the computed predictive trait values, or the test set; and
display, at the predictive trait UI, the generated explanations.
